(19) United States
(12) Patent Application Publication
(10) Pub. No.: US 2019/0285457 A1
(43) Pub. Date: Sep. 19, 2019

(54) LIQUID CONTAINER AND LIQUID CONTAINER MANAGEMENT SYSTEM

(71) Applicants: Thermos L.L.C, Schaumburg, IL (US); Thermos K.K., Niigata (JP)

(72) Inventor: Toshiyuki Watanabe, Niigata (JP)

(21) Appl. No.: 16/351,987

(22) Filed: Mar. 13, 2019

(30) Foreign Application Priority Data
Mar. 15, 2018 (JP) 2018-048285

(51) Int. Cl. G01F 23/00; A47G 19/12; G01C 9/08; G01K 7/22

(52) U.S. Cl. CPC G01F 23/0061; G01K 7/22; G01C 9/08; A47G 19/12

(57) ABSTRACT

A liquid container having improved convenience while considering sanitation is described. The liquid container includes a first temperature sensor to measure a temperature around the inside of the liquid container while not contacting a liquid inside a container body, a second temperature sensor which measures a temperature of an environment provided with the liquid container while not contacting the liquid inside the liquid container body, and a calculation processing unit to estimate a liquid temperature inside the liquid container on the basis of the temperature around the inside of the liquid container measured by the first temperature sensor and the temperature of the environment measured by the second temperature sensor.

### CROSS REFERENCE TO RELATED APPLICATION

This application claims priority to Japan Patent Application No. JP2018-048285 filed Mar. 15, 2018, which is hereby incorporated by reference.

### BACKGROUND OF THE INVENTION

### Field of the Invention

The present invention relates to a liquid container and a liquid container management system.

### Background Art

Conventionally, a technique of detecting a liquid amount and a liquid temperature inside a liquid container by using a liquid amount/liquid temperature detection unit has been proposed. Further, a technique of measuring detection information involved with a liquid stored in a container body on the basis of a plurality of detection modules and controlling the opening and closing of a liquid container has been proposed.

### SUMMARY OF THE INVENTION

### Technical Problem

When the liquid amount/liquid temperature detection unit is inserted into the liquid container, the liquid amount/liquid temperature detection unit comes into contact with the liquid. Therefore, there is a possibility of a problem in sanitation.

Further, when the opening and closing of the liquid container is controlled at all times, power consumption increases and convenience decreases.

In this way, it is difficult to improve convenience while considering sanitation. Furthermore, such a problem is not limited to containers for storing beverages but is a problem common to all containers for storing liquids such as food cans.

In view of the above-described circumstances, an object of the present invention is to provide a technique capable of improving convenience while considering sanitation.

In order to attain the above-described object, the present invention provides a liquid container including a first temperature sensor which is configured to measure a temperature around the inside of the liquid container while not coming into contact with a liquid inside a container body, a second temperature sensor which is configured to measure a temperature of an environment provided with the liquid container while not contacting the liquid inside the liquid container body, and a calculation processing unit which is configured to estimate a liquid temperature inside the liquid container on the basis of the temperature around the inside of the liquid container measured by the first temperature sensor and the temperature of the environment measured by the second temperature sensor.

In the liquid container, the calculation processing unit may estimate the liquid temperature inside the liquid container on the basis of a correlation between the liquid temperature inside the liquid container and the temperature of a portion provided with the first temperature sensor measured in advance and a correlation between the temperature of the portion provided with the first temperature sensor and the temperature of a portion provided with the second temperature sensor measured in advance.

In the liquid container, the calculation processing unit may notify or otherwise indicate any one or both of a liquid temperature estimated value and a liquid temperature warning inside the liquid container when the liquid temperature estimated value inside the liquid container satisfies a condition for executing a warning notification on the liquid temperature.

In the liquid container, the calculation processing unit may estimate the liquid temperature inside the liquid container for a predetermined period, calculate a liquid temperature change rate by using the liquid temperature estimated value inside the liquid container for a predetermined period, and determine that the liquid container has a failure when the calculated liquid temperature change rate is higher than a comparison liquid temperature change rate.

In order to attain the above-described object, the present invention provides a liquid container management system including a liquid container which is configured to store a liquid and a management device which is configured to manage the liquid container, wherein the liquid container includes a first temperature sensor which is configured to measure a temperature around the inside of the liquid container while not contacting a liquid inside the liquid container body, a second temperature sensor which is configured to measure a temperature of an environment provided with the liquid container while not contacting the liquid inside the liquid container body, and a communication unit which is configured to transmit the temperature around the inside of the liquid container measured by the first temperature sensor and the temperature of the environment measured by the second temperature sensor to the management device, and wherein the management device includes a calculation processing unit which is configured to estimate a liquid temperature inside the liquid container on the basis of the temperature around the inside of the liquid container and the temperature of the environment transmitted from the liquid container.

In the liquid container management system, the calculation processing unit may estimate the liquid temperature inside the liquid container on the basis of a correlation between the liquid temperature inside the liquid container and the temperature of a portion provided with the first temperature sensor measured in advance and a correlation between the temperature of the portion provided with the first temperature sensor and the temperature of a portion provided with the second temperature sensor measured in advance.

In the liquid container management system, the calculation processing unit may notify any one or both of a liquid temperature estimated value and a liquid temperature warning inside the liquid container when the liquid temperature estimated value inside the liquid container satisfies a condition for executing a warning notification on the liquid temperature.

In the liquid container management system, the management device may acquire information necessary to determine whether the liquid container has a failure from a factor other than the management device and the calculation processing unit may determine that the liquid container has a failure when the acquired information satisfies a condition for determining that the liquid container has a failure.

In the liquid container management system, the calculation processing unit may estimate the liquid temperature inside the liquid container for a predetermined period, calculate a liquid temperature change rate by using the liquid temperature estimated value inside the liquid container for a predetermined period, and determine that the liquid container has a failure when the calculated liquid temperature change rate is higher than a comparison liquid temperature change rate.

According to the liquid container and the liquid container management system of the present invention, since the sensor may not be in directly contact with the liquid, it is easy to clean the liquid container while considering sanitation.

Further, the temperature around the inside of the liquid container is measured by the first temperature sensor which is configured to measure the temperature while not contacting the liquid inside the liquid container body, the temperature of the environment provided with the liquid container is measured by the second temperature sensor which is configured to measure the temperature while not contacting the liquid inside the liquid container body, and the liquid temperature is estimated from the temperature measurement values. For this reason, since it is possible to estimate the liquid temperature inside the liquid container without separating the pouring cover, usability is improved. As a result, it is possible to improve convenience while considering sanitation.

### BRIEF DESCRIPTION OF THE DRAWINGS

FIG. 1 is a diagram showing an example of a configuration of a liquid container 10.

FIG. 2 is a schematic block diagram showing a functional configuration of a control device 35 of a first embodiment.

FIG. 3 is a flowchart showing a flow of a process of the liquid container 10 of the first embodiment.

FIG. 4 is a diagram showing another example of the liquid container 10.

FIG. 5 is a diagram showing a system configuration of a management system 100a to which the liquid container of the first embodiment is applied in a second embodiment.

FIG. 6 is a schematic block diagram showing a functional configuration of a control device 35a of the second embodiment.

FIG. 7 is a schematic block diagram showing a functional configuration of a management device 40 of the second embodiment.

FIG. 8 is a sequence diagram showing a flow of an operation of the management system 100a of the second embodiment.

FIG. 9 is a sequence diagram showing a flow of an operation of a management system 100a of a modified embodiment of the second embodiment.

FIG. 10 is a diagram showing a system configuration of a management system 100b to which the liquid container of the first embodiment is applied in a third embodiment.

FIG. 11 is a diagram showing an example of a configuration of a liquid container 10c of a fourth embodiment.

FIG. 12 is a schematic block diagram showing a functional configuration of a control device 35c of the fourth embodiment.

FIG. 13 is a diagram showing an example of a liquid amount estimation table.

FIG. 14 is a flowchart showing a flow of a process of the liquid container 10c of the fourth embodiment.

FIG. 15 is a diagram showing a test example when a liquid amount is estimated by a correction.

FIG. 16 is a schematic block diagram showing a functional configuration of a control device 35d of a fifth embodiment.

FIG. 17 is a schematic block diagram showing a functional configuration of a management device 40d of the fifth embodiment.

FIG. 18 is a sequence diagram showing a flow of an operation of a management system 100d of the fifth embodiment.

FIG. 19 is a diagram showing a display example displayed on a display unit 403 of the management device 40d of the fifth embodiment.

FIG. 20 is a sequence diagram showing a flow of an operation of a management system 100d of a modified embodiment of the fifth embodiment.

### DETAILED DESCRIPTION OF THE INVENTION

In this section, an embodiment of the present invention will be described with reference to the drawings. However, the scope of the invention is not limited by the exact embodiments illustrated. Elements that have a similar or the same function (as known by a person having ordinary skill in the art) as those described are within the scope of this application.

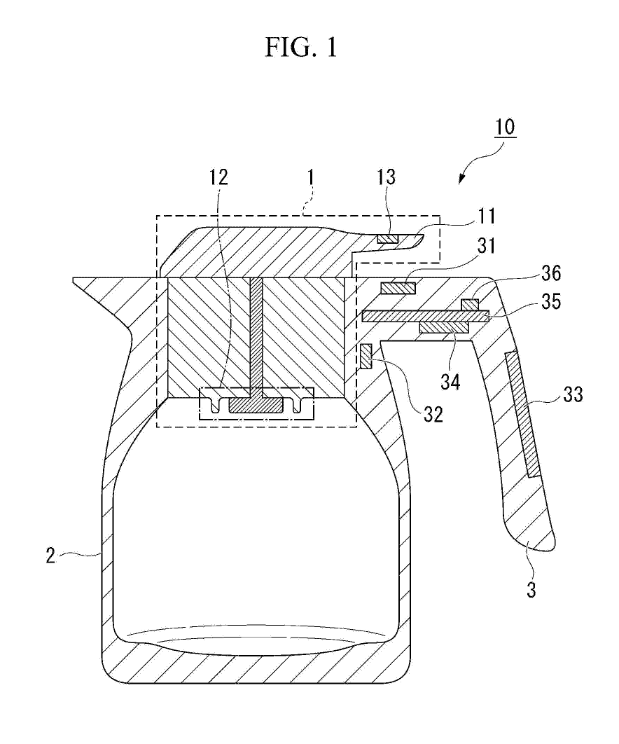

FIG. 1 is a diagram showing an example of a configuration of a liquid container 10.

The liquid container 10 is a container used to store beverages. For example, the liquid container 10 is a pot such as a water bottle, a portable mug, a tumbler, a desktop pot, an electric kettle, and a coffee maker. FIG. 1 shows a case in which the liquid container 10 is a desktop pot.

### First Embodiment

The liquid container 10 includes a pouring cover 1 and a container body 2. The pouring cover 1 is separable from the liquid container body 2 and is provided in an opening portion of the liquid container body 2. The pouring cover 1 is provided with a discharge lever 11 and a discharge valve 12. The discharge lever 11 is a pressing portion used to open and close the discharge valve 12. The discharge lever 11 is provided with a magnet 13. The discharge valve 12 is fully closed while the discharge lever 11 is not pressed, but the discharge valve 12 opens when the discharge lever 11 is pressed. That is, the pouring cover 1 allows a liquid inside the liquid container body 2 to be discharged when the discharge lever 11 is pressed.

The liquid container body 2 is, for example, a heat insulation structure having a heat insulation layer and the heat insulation layer is provided between an inner container and an outer container while the upper ends of the inner and outer containers opened upward are integrally bonded to each other. The pouring cover 1 is fitted and fixed to an opening side peripheral edge portion of the liquid container body 2, both facing surfaces are connected to each other by male and female screws. For example, an elastic member such as silicon rubber or elastomer is provided between the facing surfaces to maintain air tightness and water tightness. With such a configuration, the liquid container 10 is configured as a container which is able to maintain a constant temperature. Furthermore, the liquid container body 2 may be formed of metal (for example, stainless steel, aluminum, and titanium) or may be formed of resin.

A grip 3 of the liquid container body 2 is provided with an opening detection unit 31, a first temperature sensor 32, a display unit 33, a battery 34, a control device 35, and a second temperature sensor 36. The opening detection unit 31, the first temperature sensor 32, the display unit 33, the battery 34, the control device 35, and the second temperature sensor 36 may be provided in the grip 3 as one device or may be provided in the grip 3 while only a part of functions is provided as one device. The opening detection unit 31, the first temperature sensor 32, the display unit 33, the battery 34, the control device 35, and the second temperature sensor 36 are connected through, for example, lead wires.

The opening detection unit 31 is provided at a position facing the magnet 13.

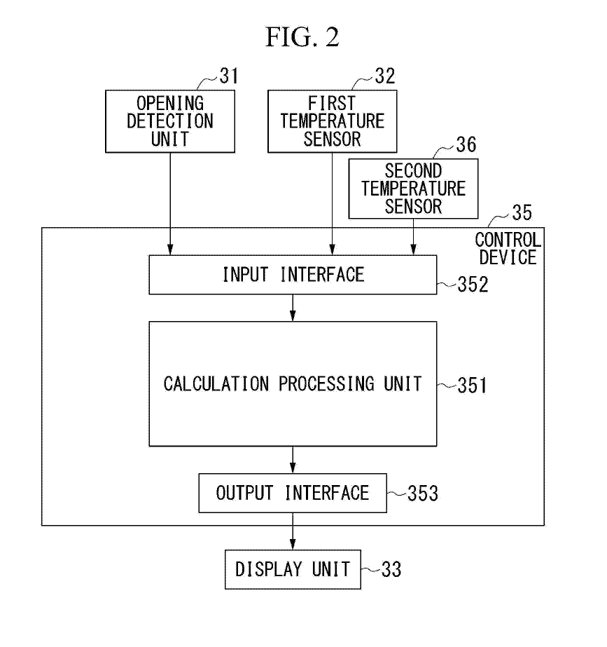

The opening detection unit 31 is, for example, a magnetic sensor (Hall IC). The opening detection unit 31 detects a magnetic field by using a Hall effect. The opening detection unit 31 detects the strength of the magnetic field and outputs the detection result to a calculation processing unit 351 inside the control device 35 as opening detection information through an input interface 352 (see FIG. 2).

The first temperature sensor 32 is a temperature sensor which does not contact the liquid inside the liquid container body 2. The first temperature sensor 32 is, for example, a thermistor. The first temperature sensor 32 is disposed at a position which is not in contact with the liquid inside the liquid container body 2 and is provided inside a resin member above the liquid container body 2 (for example, a peripheral portion of the metal container integrated with the grip 3) or inside the pouring cover 1. The first temperature sensor 32 measures the temperature around the inside of the liquid container body 2 while not contacting the liquid inside the liquid container body 2. That is, the first temperature sensor 32 measures the temperature around the inside of the liquid container body 2 while not contacting the liquid inside the liquid container body 2. The first temperature sensor 32 outputs the measured temperature around the inside of the liquid container body 2 to the control device 35 as inner temperature information.

The display unit 33 is an image display device such as a liquid crystal display or an organic EL (Electro Luminescence) display. The display unit 33 displays information about the inside of the liquid container body 2. The information about the inside of the liquid container body 2 means, for example, a liquid temperature or an abnormality inside the liquid container body 2. The display unit 33 may be a touch panel.

The battery 34 supplies power to the opening detection unit 31, the first temperature sensor 32, the display unit 33, the control device 35, and the second temperature sensor 36.

The calculation processing unit inside the control device 35 detects the opening and closing of the liquid container body 2 on the basis of the opening detection information of the opening detection unit 31. Further, the control device 35 estimates the liquid temperature inside the liquid container body 2 on the basis of the inner temperature information output from the first temperature sensor 32 and outer temperature information output from the second temperature sensor 36 and displays the estimation result on the display unit 33.

Similarly to the first temperature sensor 32, the second temperature sensor 36 is a temperature sensor which does not contact the liquid inside the liquid container body 2. The second temperature sensor 36 is, for example, a thermistor. The second temperature sensor 36 can be provided in, for example, the grip 3 or the like to be located at a position separated from the opening portion of the liquid container body 2 in relation to the first temperature sensor 32. The second temperature sensor 36 measures the temperature of the environment provided with the liquid container 10. More specifically, the second temperature sensor 36 measures the temperature of the environment provided with the liquid container 10 while not contacting the liquid inside the liquid container body 2.

The second temperature sensor 36 outputs the temperature of the measurement environment to the control device 35 as the outer temperature information.

Furthermore, in the description below, the inner temperature information and the outer temperature information will be simply described as temperature information unless otherwise specified.

FIG. 2 is a schematic block diagram showing a functional configuration of the control device 35 of the first embodiment. The control device 35 includes the calculation processing unit 351 provided with a CPU (Central Processing Unit) and a memory and serves as a device which controls the input/output control by the execution of the control program, estimates the liquid temperature, and performs a warning of the liquid temperature. Furthermore, all or a part of the functions of the control device 35 may be realized by using hardware such as ASIC (Application Specific Integrated Circuit), PLD (Programmable Logic Device), or FPGA (Field Programmable Gate Array).

Further, the control program may be recorded on a non-transient computer readable recording medium. The computer readable recording medium is, for example, a recording device corresponding to a portable medium such as a Secure Digital (SD) card and a Universal Serial Bus (USB) and a hard disk built in a computer system. Further, the control program may be transmitted and received through an electric communication line.

The calculation processing unit 351 inputs and outputs information by the execution of the input/output control program. For example, the calculation processing unit 351 inputs the opening detection information and the temperature information. The input/output control program is a program for executing information input/output using the calculation processing unit. The calculation processing unit 351 acquires the opening detection information through the input interface 352 and detects the opening of the discharge valve 12 on the basis of the acquired opening detection information.

Further, the calculation processing unit 351 estimates the liquid temperature inside the liquid container body 2 on the basis of the inner temperature information and the outer temperature information. Then, the calculation processing unit 351 controls the display of the display unit 33 on the basis of the estimation result. Specifically, the calculation processing unit 351 acquires the inner temperature information inside the liquid container body 2 from the first temperature sensor 32 and the outer temperature information from the second temperature sensor 36 through the input interface 352. Further, the calculation processing unit 351 estimates the liquid temperature by executing the liquid temperature estimation program on the basis of a correlation between the liquid temperature inside the liquid container body 2 and the temperature (the inner temperature information) of the attachment portion of the first temperature sensor 32 which are measured in advance and a correlation between the temperature (the inner temperature information) of the attachment portion of the first temperature sensor 32 and the temperature (the outer temperature information) of the attachment portion of the second temperature sensor 36 which are measured in advance. The liquid temperature estimation program is a program for estimating the liquid temperature inside the liquid container body 2 using the calculation processing unit.

Further, the calculation processing unit 351 determines whether the estimated liquid temperature is lower than a liquid temperature set value when a hot beverage is put in the liquid container body 2 by executing a liquid temperature warning program. The liquid temperature warning program is a program for executing a warning notification on the liquid temperature by the calculation processing unit. The liquid temperature warning is, for example, information that the liquid temperature is decreasing. The calculation processing unit 351 determines whether the estimated liquid temperature is equal to or higher than the liquid temperature set value when a cold beverage is put in the liquid container body 2. Furthermore, a state in which the hot beverage or the cold beverage is put in the liquid container body 2 may be input in advance or may be determined from the liquid temperature estimated by the calculation processing unit 351. The liquid temperature set value may be set in advance or may be changed periodically. The calculation processing unit 351 controls the display of the display unit 33 through an output interface 353 on the basis of the determination result. In the description below, all instances of the liquid temperature warning program are the same, but only the hot beverage will be described for simplicity.

The output interface 353 is an interface which outputs a result, which is obtained by the processing of the calculation processing unit 351, to the display unit 33.

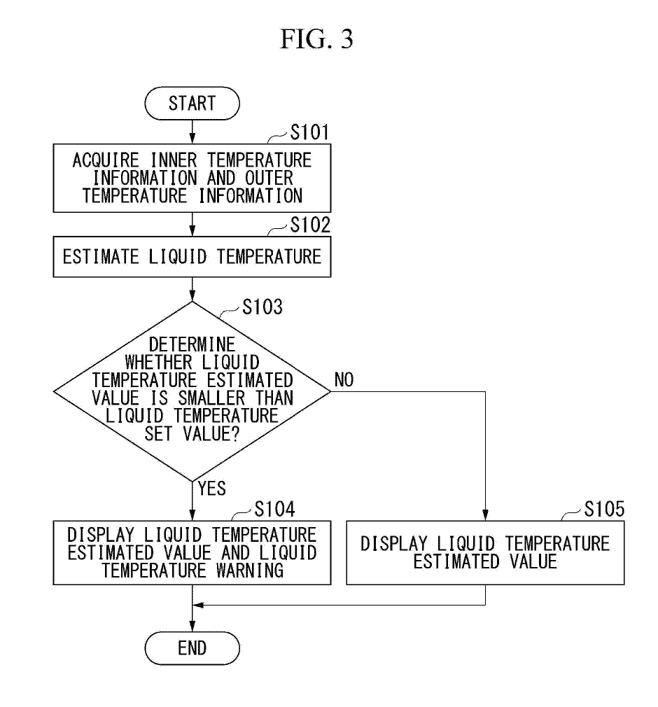

FIG. 3 is a flowchart showing a flow of the liquid temperature estimation process and the liquid temperature warning process of the liquid container 10 of the first embodiment. Further, the liquid temperature estimation process and the liquid temperature warning process are performed regardless of whether the discharge valve 12 is to be opened or closed. For example, the liquid temperature estimation process and the liquid temperature warning process may be performed periodically or may be performed at a predetermined timing.

The calculation processing unit 351 acquires the inner temperature information and the outer temperature information from the first temperature sensor 32 and the second temperature sensor 36 through the input interface 352 (step S101).

The calculation processing unit 351 estimates the liquid temperature on the basis of the inner temperature information and the outer temperature information (step S102). The calculation processing unit 351 determines whether the liquid temperature estimated value is smaller than the liquid temperature set value (step S103). When the liquid temperature estimated value is smaller than the liquid temperature set value (step S103—YES), the calculation processing unit 351 displays the liquid temperature estimated value and the liquid temperature warning on the display unit 33 by executing the liquid temperature warning program (step S104).

Furthermore, the calculation processing unit 351 may display the liquid temperature estimated value and the liquid temperature warning on the display unit 33 in any manner. For example, the calculation processing unit 351 may display the liquid temperature estimated value as a graph and display the liquid temperature warning as letters. The liquid temperature estimated value may be displayed as a number and the liquid temperature warning may be displayed as letters. Further, other displays may be used.

Meanwhile, when the liquid temperature estimated value is not smaller than the liquid temperature set value (step S103—NO), the calculation processing unit 351 displays the liquid temperature estimated value on the display unit 33 (step S105). Furthermore, the calculation processing unit 351 may display the liquid temperature estimated value on the display unit 33 in any manner. For example, the calculation processing unit 351 may display the liquid temperature estimated value as a graph. The liquid temperature estimated value may be displayed as a number. Further, other displays may be used.

According to the liquid container 10 with such a configuration, it is possible to improve convenience while considering sanitation. Specifically, the liquid container 10 estimates the liquid temperature on the basis of the temperature of the environment provided with the liquid container 10 and the temperature around the inside of the liquid container 10 and displays information on the liquid temperature on the basis of the estimated liquid temperature. Thus, the user can easily perceive the liquid temperature inside the liquid container 10 without separating the pouring cover 1. Accordingly, the user can determine whether to replace the liquid inside the liquid container 10 in response to the liquid temperature. Further, in order to estimate the liquid temperature, the sensor need not be in direct contact with the liquid. Thus, it is sanitary. For that reason, it is possible to improve convenience while considering sanitation.

Conventionally, there is a product which senses a liquid temperature and a liquid amount by inserting a temperature sensor into a liquid. In this case, since the sensor is immersed into the beverage at all times, a sensor accommodation portion becomes dirty. Since a resin member is generally used for the sensor accommodation portion, the resin member becomes dirty easily as compared with metal. Particularly, in the case of a beverage such as coffee, the sensor accommodation portion is easily discolored. Thus, when the sensor accommodation portion is not cleaned diligently, there is a possibility that the sensor or the sensor accommodation portion may be discolored. In contrast, in the embodiment, since the temperature sensor can be attached at a position which is not immersed into the liquid in a normal usage state, the temperature sensor does not become dirty and hence the sensor is sanitary. Here, the position which is not immersed into the liquid in a normal usage state is indicated as, for example, the inside of the resinous component (for example, the grip 3, a peripheral portion of the metal container integrated with the grip 3, and the pouring cover 1). Further, when the sensor accommodation portion comes into contact with a high-temperature liquid such as hot coffee, there is a possibility that the deterioration of the sensor accommodation portion may be promoted. However, in the embodiment, the possibility can be eliminated. Further, it is possible to accommodate the opening detection unit 31, the display unit 33, the control device 35, and the second temperature sensor 36 compactly in the grip 3.

Further, the liquid container 10 estimates the liquid temperature and displays the estimation result on the display unit 33. For that reason, the user can recognize the liquid temperature without opening the pouring cover 1 in the opaque container.

Further, all function units that display a liquid temperature by estimation are provided in the grip 3. For that reason, even when a malfunction occurs due to a failure or the like, a repair or replacement becomes easy.

<Modified Embodiment>

The liquid container 10 may not include the opening detection unit 31.

In the embodiment, the first temperature sensor 32 and the control device 35 may be electrically connected to each other by providing the first temperature sensor 32 inside the pouring cover 1 and attaching the pouring cover 1 to the liquid container body 2.

When the liquid temperature estimated value is smaller than the liquid temperature set value, the liquid container 10 may display a warning that the liquid temperature estimated value is smaller than the liquid temperature set value and notify the user about the corresponding liquid container 10 in a notification mode different from that of the display. The notification mode different from the display may be a notification by an alarm. It may be a notification by light emission. It may be a notification by a sound notification. Furthermore, other notifications may be used.

The calculation processing unit 351 of the liquid container 10 may perform an abnormality determination based on the liquid temperature estimated value in addition to the above-described determination based on the liquid temperature when the liquid container 10 is the liquid container 10 having a heat insulation structure. Specifically, first, the calculation processing unit 351 acquires the temperature information at a specified interval (for example, an interval of 1 minute) and estimates the liquid temperature. Next, the calculation processing unit 351 calculates a liquid temperature change rate estimated for a predetermined period. Next, the calculation processing unit 351 compares the calculated liquid temperature change rate and a predetermined liquid temperature change rate with each other. Then, the calculation processing unit 351 determines whether the heat insulating performance of the liquid container 10 is maintained on the basis of the comparison result.

The calculation processing unit 351 determines that the liquid container 10 has a failure (insufficient thermal insulation performance) when the liquid temperature change rate is higher than the comparison liquid temperature change rate (quickly cold and warm). Furthermore, the information of the comparison liquid temperature change rate may be recorded in the calculation processing unit 351 or may be acquired from a memory. When it is determined that the liquid container 10 has a failure, the calculation processing unit 351 displays a warning on the display unit 33.

Meanwhile, when the liquid temperature change rate is lower than the comparison liquid temperature change rate, it is determined that the liquid container 10 does not have a failure (sufficient thermal insulation performance).

The calculation processing unit 351 may be configured to determine whether each of the value of the temperature around the inside of the liquid container body 2 indicated by the inner temperature information acquired from the first temperature sensor 32 and the value of the temperature in the environment provided with the liquid container 10 indicated by the outer temperature information acquired from the second temperature sensor 36 is inside the first specified range. The first specified range is a determination reference used to determine whether the first temperature sensor 32 and the second temperature sensor 36 have a failure and is, for example, 0 to 100° C. Furthermore, the first specified range is not limited to the above-described range and may be set appropriately. The information of the first specified range may be recorded in the calculation processing unit 351 or may be acquired from a memory.

When the value of the temperature around the inside of the liquid container body 2 indicated by the inner temperature information and the value of the temperature in the environment provided with the liquid container 10 indicated by the outer temperature information are inside the first specified range, the calculation processing unit 351 determines that the first temperature sensor 32 and the second temperature sensor 36 are normal. When the value of the temperature around the inside of the liquid container body 2 is outside the first specified range, the calculation processing unit 351 determines that the first temperature sensor 32 has an abnormality (failure). When the value of the temperature in the environment provided with the liquid container 10 is outside the first specified range, the calculation processing unit 351 determines that the second temperature sensor 36 has an abnormality (failure).

When the value of the temperature around the inside of the liquid container body 2 is outside the first specified range, the calculation processing unit 351 may display the possibility that the first temperature sensor 32 has a failure on the display unit 33. When the value of the temperature in the environment provided with the liquid container 10 is outside the first specified range, the calculation processing unit 351 may display the possibility that the second temperature sensor 36 has a failure on the display unit 33. When the value of the temperature around the inside of the liquid container body 2 and the value of the temperature in the environment provided with the liquid container 10 are outside the first specified range, the calculation processing unit 351 may display the possibility that the first temperature sensor 32 and the second temperature sensor 36 have a failure on the display unit 33.

In the embodiment, a configuration in which the magnet 13 and the opening detection unit 31 are used as means for detecting the opening of the liquid container 10 has been described, but the present invention is not limited thereto. For example, the liquid container 10 may include a detection unit in which a switch is provided in the upper portion of the grip 3 of the liquid container 10 (for example, a portion to which the discharge lever 11 moves when the discharge lever 11 is pressed down) and the opening is detected when the switch is pressed down by the discharge lever 11. In this case, the liquid container 10 may not include the magnet 13 and the opening detection unit 31.

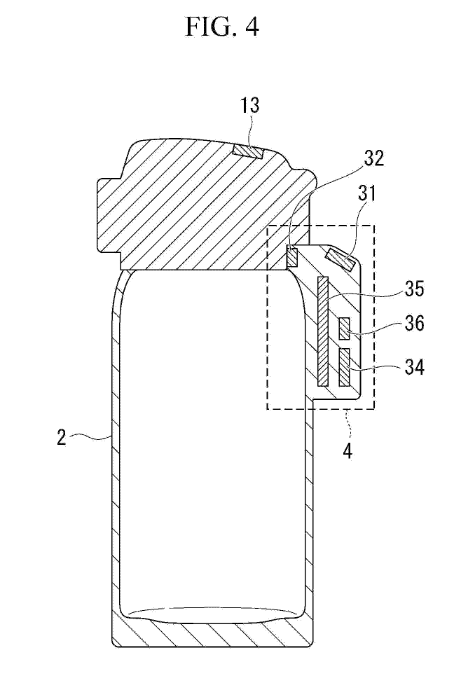

In the embodiment, an example of a desktop pot having the grip 3 has been described as the liquid container 10, but a container without the grip 3 also exists in accordance with the liquid container 10. As the liquid container 10 without the grip 3, for example, water bottles, portable mugs, and tumblers are exemplary examples. The liquid container 10 without the grip 3 may be configured as shown in FIG. 4. FIG. 4 is a diagram showing another example of the liquid container 10. As shown in FIG. 4, the magnet 13 is provided in the lid of the liquid container 10 and the opening detection unit 31, the first temperature sensor 32, the battery 34, the control device 35, and the second temperature sensor 36 are accommodated in an accommodation unit 4 attached to the liquid container body 2. Furthermore, in the example of FIG. 4, the magnet 13 moves toward the opening detection unit 31 when the lid is open, but the magnet 13 may move away from the opening detection unit 31 when the lid is open.

Further, the calculation processing unit 351 may be configured to shift to the power saving mode when the opening state of the discharge valve 12 is not detected. The power saving mode is a mode that limits power consumption by limiting the operation of a part of functions inside the device. In the case of the embodiment, the calculation processing unit 351 limits the operation of acquiring the temperature information when the opening of the discharge valve 12 is not detected.

Specifically, the calculation processing unit 351 stops the supply of power for operating the first temperature sensor 32 and the second temperature sensor 36 when the opening of the discharge valve 12 is not detected. Then, when the opening of the discharge valve 12 is detected, the calculation processing unit 351 supplies power to any one or both of the first temperature sensor 32 and the second temperature sensor 36 and activates any one or both of the first temperature sensor 32 and the second temperature sensor 36.

With such a configuration, the first temperature sensor 32 and the second temperature sensor 36 cannot acquire the inner temperature information and the outer temperature information when the opening of the discharge valve 12 is not detected. For that reason, it is possible to limit power consumption.

The calculation processing unit 351 may be configured to acquire the temperature information when the liquid discharge operation is being performed. In the case of such a configuration, the calculation processing unit 351 acquires the inner temperature information and the outer temperature information from the first temperature sensor 32 and the second temperature sensor 36 through the input interface 352 while the liquid discharge operation is performed.

### Second Embodiment

In a second embodiment, a first example of a system to which the liquid container of the first embodiment is applied will be described.

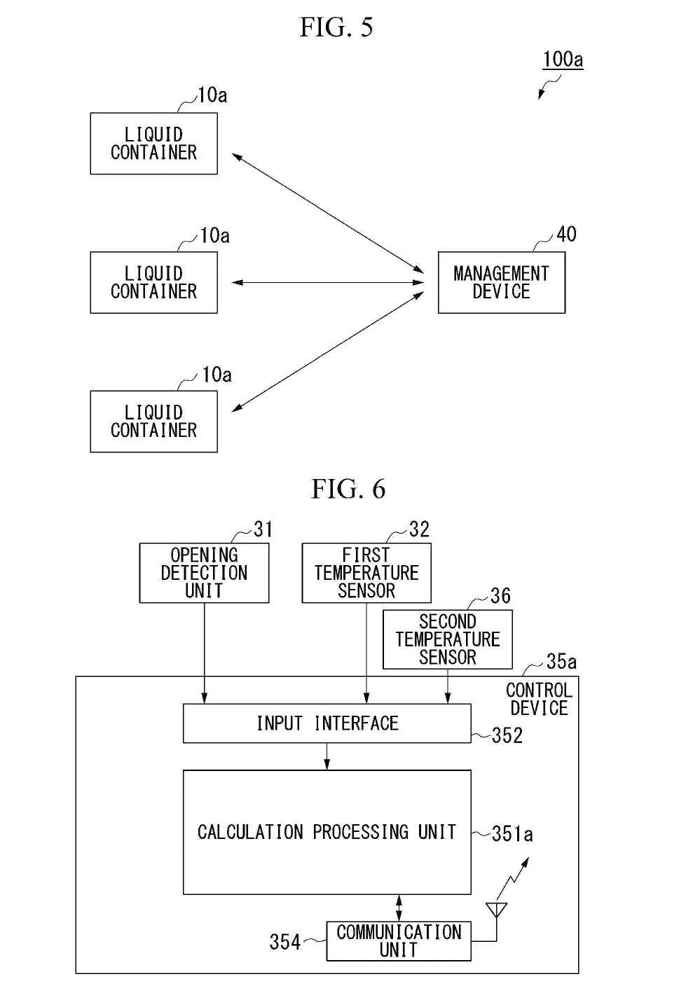

FIG. 5 is a diagram showing a system configuration of a management system 100a to which the liquid container of the first embodiment is applied in the second embodiment.

The management system 100a is applied to a facility including a food space. The facility including the food space is, for example, a restaurant, a game hall, or the like. The management system 100a includes a liquid container 10a and a management device 40.

The liquid container 10a includes the pouring cover 1 and the liquid container body 2. The configuration of the liquid container 10a is different from that of the liquid container 10 in that the liquid container body 2 includes the control device 35a instead of the control device 35 and does not include the display unit 33. Since the other configurations of the liquid container 10a are the same as those of the liquid container 10, a description thereof will be omitted. The control device 35a transmits the temperature information to the management device 40.

The management device 40 is configured as, for example, an information processing device such as a smart phone, a mobile phone, a tablet terminal, a notebook computer, and a personal computer. The management device 40 manages the liquid container 10a. For example, the management device 40 estimates the liquid temperature inside the liquid container body 2 of each liquid container 10a on the basis of the temperature information transmitted from the liquid container 10a and displays the liquid temperature estimated value or the liquid temperature warning of each liquid container 10a.

The management system 100a includes one or plural liquid containers 10a. The liquid container 10a and the management device 40 perform wireless communication by Bluetooth (trademark). In the description below, an example of a case in which the management system 100a is applied to a restaurant will be described. In this case, it is assumed that the liquid container 10a is provided at each table.

FIG. 6 is a schematic block diagram showing a functional configuration of the control device 35a of the second embodiment. The control device 35a includes a communication unit 354 and a calculation processing unit 351a equipped with a CPU or a memory and serves as a device which performs input/output control by the execution of the control program. Furthermore, all or a part of the functions of the control device 35a may be realized by using hardware such as ASIC, PLD, or FPGA. Further, the control program may be recorded on a computer readable recording medium. The computer readable recording medium is, for example, a recording device such as an SD card, a portable medium such as a USB, and a hard disk built in a computer system. Further, the control program may be transmitted and received through an electric communication line.

The configuration of the control device 35a is different from that of the control device 35 in that the communication unit 354 is additionally provided and the calculation processing unit 351a does not execute the liquid temperature estimation program and the liquid temperature warning program. The other configurations of the control device 35a are the same as those of the control device 35. For that reason, a description of the entire control device 35a will be omitted.

The calculation processing unit 351a performs an information input/output by the execution of the input/output control program. For example, the calculation processing unit 351a inputs the opening detection information, the inner temperature information, and the outer temperature information. The calculation processing unit 351a acquires the temperature information (the inner temperature information and the outer temperature information) through the input interface 352 and transmits the acquired temperature information to the management device 40.

The communication unit 354 communicates with the management device 40. For example, the communication unit 354 correlates the temperature information acquired through the input interface 352 with an ID (hereinafter, referred to as a “container ID”) for identifying the present device and transmits the information to the management device 40 as notification information.

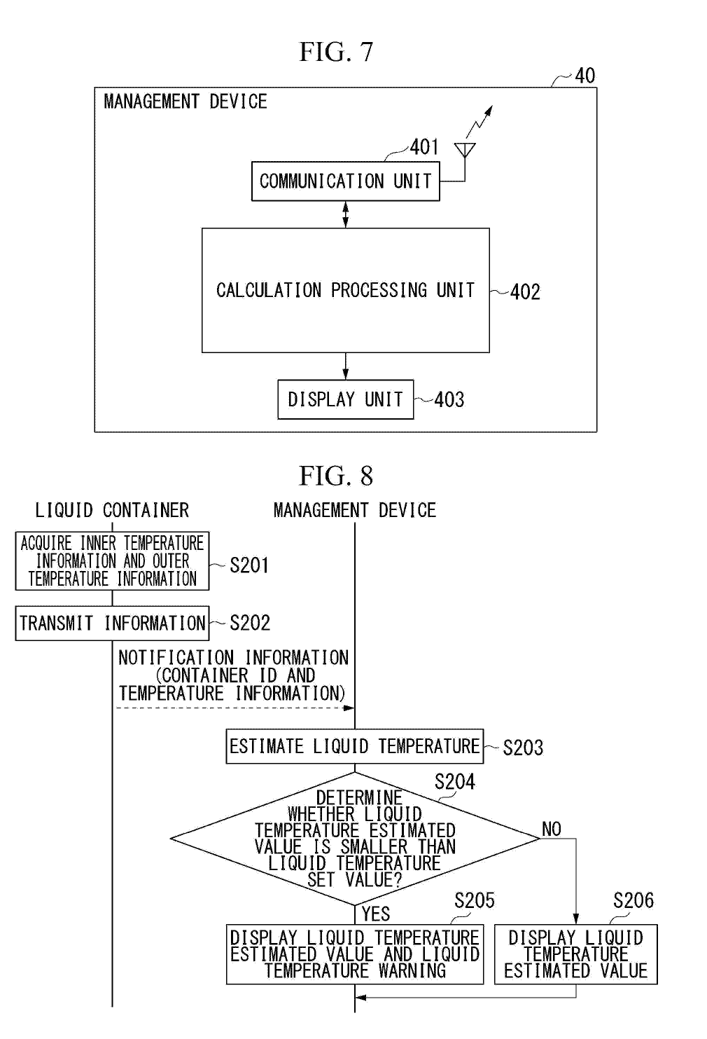

FIG. 7 is a schematic block diagram showing a functional configuration of the management device 40 of the second embodiment. The management device 40 includes a communication unit 401, a calculation processing unit 402, and a display unit 403 and serves as a device that performs input/output control, a liquid temperature estimation, and a liquid temperature warning by the execution of the management program.

Furthermore, all or a part of the functions of the management device 40 may be realized by using hardware such as ASIC, PLD, or FPGA. Further, the management program may be recorded on a computer readable recording medium. The computer readable recording medium is, for example, a recording device corresponding to a flexible disk, a magneto-optical disk, a portable medium such as a ROM and a CD-ROM, and a hard disk built in a computer system. Further, the management program may be transmitted and received through an electric communication line.

The communication unit 401 communicates with the liquid container 10a. For example, the communication unit 401 receives the notification information transmitted from the liquid container 10a.

The calculation processing unit 402 estimates the liquid temperature inside the liquid container body 2 of each liquid container 10a by executing the liquid temperature estimation program using the notification information received by the communication unit 401. The calculation processing unit 402 determines whether the liquid temperature estimated value estimated by the liquid temperature warning program is smaller than the liquid temperature set value. The calculation processing unit 402 controls the display of the display unit 403 on the basis of the determination result.

The display unit 403 is an image display device such as a liquid crystal display and an organic EL display.

The display unit 403 displays information such as a liquid amount estimated value or a liquid amount warning of each liquid container 10a.

FIG. 8 is a sequence diagram showing a flow of an operation of the management system 100a of the second embodiment. Furthermore, in the description of FIG. 8, a case in which one liquid container 10a and one management device 40 are provided will be described as an example for simplicity.

The calculation processing unit 351a acquires the inner temperature information and the outer temperature information from the first temperature sensor 32 and the second temperature sensor 36 through the input interface 352 (step S201). The calculation processing unit 351a controls the communication unit 354, correlates the acquired temperature information with the liquid container ID, and transmits the information to the management device 40 as the notification information (step S202).

The communication unit 401 of the management device 40 receives the notification information transmitted from the liquid container 10a.

The calculation processing unit 402 estimates the liquid temperature inside the liquid container body 2 of the liquid container 10a on the basis of the temperature information included in the notification information received by the communication unit 401 (step S203).

Further, an example in which one liquid container 10a is provided has been described in FIG. 8, but the calculation processing unit 402 estimates the liquid temperature inside the liquid container body 2 of each liquid container 10a when the notification information including the temperature information is received from the liquid containers 10a. Since the liquid temperature estimation method is the same as the estimation method of the calculation processing unit 351, a description thereof will be omitted.

The calculation processing unit 402 determines whether the liquid temperature estimated value is smaller than the liquid temperature set value (step S204). When the liquid temperature estimated value is smaller than the liquid temperature set value (step S204—YES), the calculation processing unit 402 displays the liquid temperature estimated value and the liquid temperature warning on the display unit 403 by executing the liquid temperature warning program (step S205). For example, since the calculation processing unit 402 executes the liquid temperature warning program similarly to the calculation processing unit 351, it is determined whether the estimated liquid temperature is lower than the liquid temperature set value when a hot beverage is put in the liquid container body 2 and it is determined whether the estimated liquid temperature is larger than the liquid temperature set value when a cold beverage is put in the liquid container body 2. Here, only the hot beverage will be described for simplicity.

Furthermore, the calculation processing unit 402 may display the liquid temperature estimated value and the liquid temperature warning on the display unit 403 in any manner. For example, the calculation processing unit 402 may display the liquid temperature estimated value as a graph and display the liquid temperature warning as letters. The liquid temperature estimated value may be displayed as a number and the liquid temperature warning may be displayed as letters. Further, another display may be used.

Meanwhile, when the liquid temperature estimated value is not smaller than the liquid temperature set value (step S204—NO), the calculation processing unit 402 displays the liquid temperature estimated value on the display unit 403 (step S206). Furthermore, the calculation processing unit 402 may display the liquid temperature estimated value on the display unit 403 in any manner.

For example, the calculation processing unit 402 may display the liquid temperature estimated value as a graph. The liquid temperature estimated value may be displayed as a number. Further, another display may be used.

According to the management system 100a with such a configuration, it is possible to improve service quality. Specifically, the liquid container 10a transmits the notification information to the management device 40.

Then, the management device 40 displays the liquid temperature estimated value of each liquid container 10a from the notification information. Accordingly, a clerk in a restaurant or the like can recognize the liquid temperature inside the liquid container body 2 of the liquid container 10a provided at each table. Then, it can be understood that a replacement is necessary if the liquid temperature is not an appropriate liquid temperature. For that reason, it is possible to improve service quality.

Further, in the management system 100a, the liquid temperature is estimated by the management device 40. Accordingly, since it is possible to reduce a calculation process by the control device 35a of the liquid container 10a and to conserve the power of the liquid container 10a, it is possible to reduce the consumption of the battery. Further, it is possible to reduce the costs involved with the liquid container 10a.

### Modified Embodiment

The management device 40 may be configured to specify the position of the liquid container 10a on the basis of the radio wave intensity of the wireless communication from the liquid container 10a.

The management system 100a may include a relay device which relays a communication between the liquid container 10a and the management device 40.

When the liquid temperature estimated value is smaller than the liquid temperature set value, the calculation processing unit 402 may display a warning that the liquid temperature estimated value is smaller than the liquid temperature set value and notify the user about the corresponding liquid container 10a in a notification mode different from that of the display. The notification mode different from the display may be a notification by an alarm. It may be a notification by light emission. It may be a notification by a sound notification. Furthermore, other notifications may be used.

Further, similarly to the calculation processing unit 351 of the first embodiment, the calculation processing unit 402 may be configured to determine the abnormality (failure) of the first temperature sensor 32 and the second temperature sensor 36. In the case of such a configuration, the calculation processing unit 402 may display the possibility that any one or both of the first temperature sensor 32 and the second temperature sensor 36 have a failure on any one or both of the display unit 33 and the display unit 403. The information of the first specified range may be included in the notification information. The information may be recorded in the calculation processing unit 402. Further, the information may be acquired from a memory.

Further, the calculation processing unit 351a may be configured to shift to the power saving mode when the opening state of the discharge valve 12 is not detected. For example, the calculation processing unit 351a limits any one or both of the acquisition of the temperature information and the operation of the communication unit 354 when the opening of the discharge valve 12 is not detected.

Specifically, the calculation processing unit 351a stops the supply of power for operating the first temperature sensor 32 and the second temperature sensor 36 when the opening of the discharge valve 12 is not detected. Further, the calculation processing unit 351a stops the supply of power for operating the communication unit 354 when the opening of the discharge valve 12 is not detected. Then, when the calculation processing unit 351a detects the opening of the discharge valve 12, power is supplied to any one or all of the first temperature sensor 32, the second temperature sensor 36, and the communication unit 354, and any one or all of the first temperature sensor 32, the second temperature sensor 36, and the communication unit 354 are activated.

With such a configuration, the first temperature sensor 32 and the second temperature sensor 36 cannot acquire the inner temperature information and the outer temperature information when the opening of the discharge valve 12 is not detected. For that reason, it is possible to limit power consumption. Further, the transmission/reception by the communication unit 354 is also stopped. For that reason, it is possible to limit power consumption.

Similarly to the first embodiment, the liquid container 10a may be configured to display the liquid temperature estimated value and the liquid temperature warning. In the case of such a configuration, the liquid container 10a is configured to include the output interface 353 and the display unit 33 shown in FIG. 2. In the case of such a configuration, one of the following two configurations is adopted in the second embodiment.

A first configuration is that the liquid temperature estimated value and the liquid temperature warning are not displayed in the liquid container 10a and any one or both of the liquid temperature estimated value and the liquid temperature warning are displayed in the management device 40 and a second configuration is set such that any one or both of the liquid temperature estimated value and the liquid temperature warning are displayed in both the liquid container 10a and the management device 40.

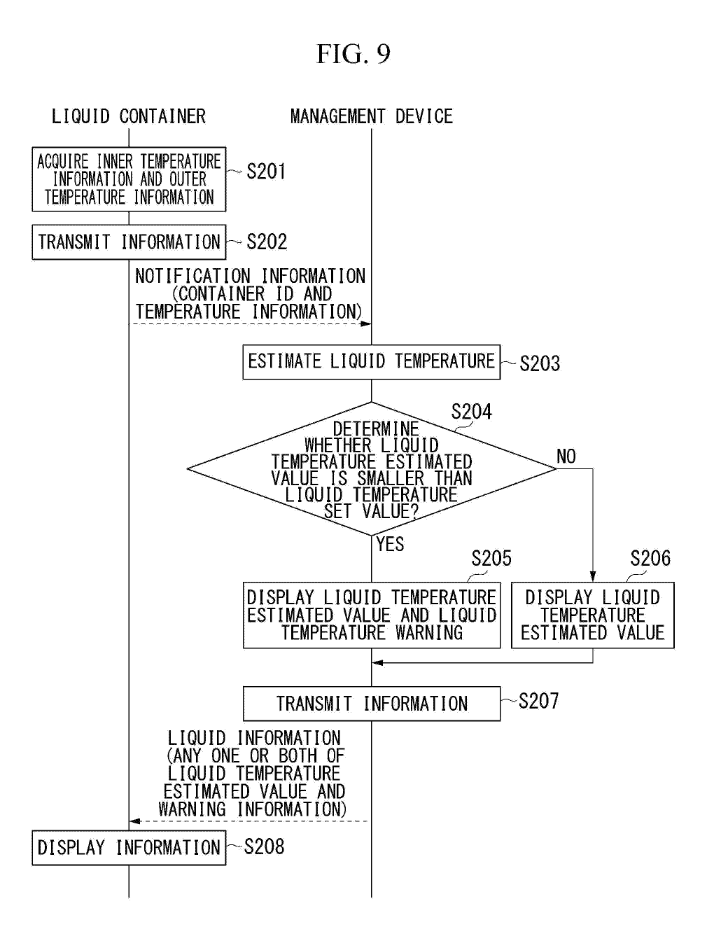

Since the first configuration has been described in the second embodiment, a description thereof will be omitted. Then, the second configuration will be described in detail below with reference to FIG. 9.

FIG. 9 is a sequence diagram showing a flow of an operation of the management system 100a of the modified embodiment of the second embodiment. In FIG. 9, since the same reference numerals as those of FIG. 8 are given to the same processes as those of FIG. 8, a description thereof will be omitted.

After the process of step S205 or step S206, when the management device 40 determines that the liquid temperature estimated value is smaller than the liquid temperature set value in the process of step S204, the liquid information including the liquid temperature estimated value and the liquid temperature warning is transmitted to the liquid container 10a (step S207). Furthermore, when there are a plurality of liquid containers 10a, the management device 40 transmits the liquid information to each liquid container 10a.

Meanwhile, when the management device 40 determines that the liquid temperature estimated value is equal to or larger than the liquid temperature set value in the process of step S204, the liquid information including only the liquid temperature estimated value is transmitted to the liquid container 10a. Furthermore, when there are a plurality of liquid containers 10a, the management device 40 transmits the liquid information including only the liquid temperature estimated value to each liquid container 10a.

The calculation processing unit 351a of the liquid container 10a displays information included in the liquid information on the display unit 33 on the basis of the liquid information transmitted from the management device 40 (step S208). Specifically, the calculation processing unit 351a displays the liquid temperature estimated value and the liquid temperature warning on the display unit 33 when the liquid temperature estimated value and the liquid temperature warning are included in the liquid information transmitted from the management device 40.

Meanwhile, the calculation processing unit 351a displays the liquid temperature estimated value on the display unit 33 when only the liquid temperature estimated value is included in the liquid information transmitted from the management device 40.

Further, in the embodiment, a configuration in which the liquid container 10a and the management device 40 wirelessly communicate with each other by Bluetooth (trademark) has been described, but the wireless communication standard is not particularly limited thereto. For example, Wi-Fi (registered trademark), Wireless Smart Utility Network (Wi-SUN) (registered trademark), Zigbee (registered trademark), specified low power radio, or the like may be used as a wireless communication standard.

### Third Embodiment

In a third embodiment, a second example of a system to which the liquid container of the first embodiment is applied will be described.

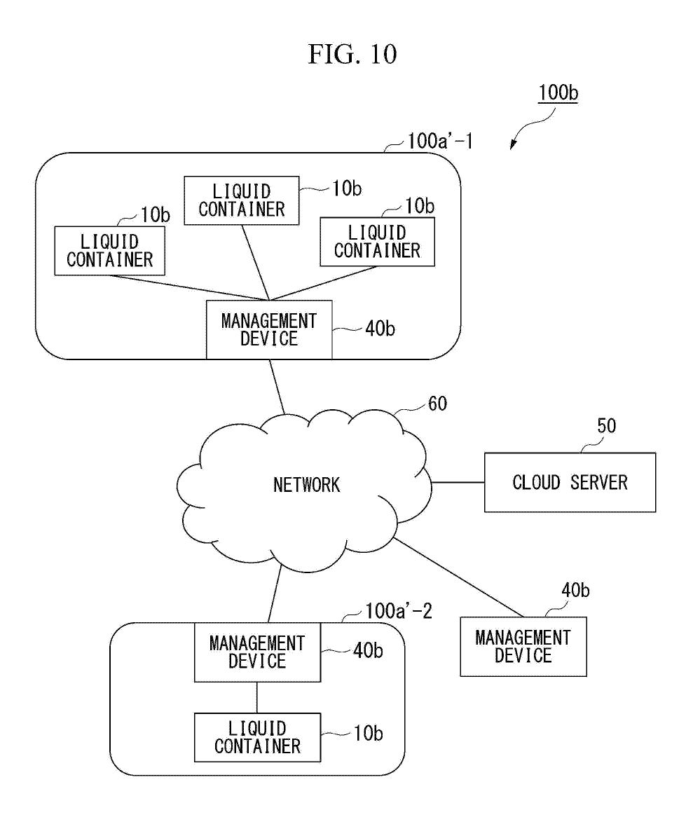

FIG. 10 is a diagram showing a system configuration of a management system 100b to which the liquid container of the first embodiment is applied in the third embodiment. The management system 100b is applied to a facility including a food space. The management system 100b includes a network 100a′-1, a network 100a′-2, a management device 40b, and a cloud server 50.

The network 100a′-1, the network 100a′-2, the management device 40b, and the cloud server 50 perform wireless communication through the network 60. The network 60 may be a network configured in any manner. For example, the network 60 may be configured using the Internet.

The network 100a′-1 and the network 100a′-2 are networks (area networks) for respective shops. The network 100a′-1 and the network 100a′-2 are provided with one or plural liquid containers 10b and a management device 40b. The management device 40b transmits the result of aggregating or analyzing the information of the liquid container 10b to the cloud server 50. Furthermore, since the configurations of the liquid container 10b and the management device 40b are the same as those of the liquid container 10a and the management device 40a of the second embodiment except that the management device 40b communicates with the cloud server 50, a description thereof will be omitted.

For example, the management device 40b transmits the liquid consumption amount for one day to the cloud server 50 at a predetermined time (for example, 12 o'clock). The cloud server 50 aggregates or analyzes the information received from the management device 40b for each area. The cloud server 50 transmits the aggregated or analyzed result to the management device 40b of the request source in response to the request from the management device 40b. Accordingly, it is possible to check the aggregated or analyzed result for each shop.

The cloud server 50 transmits information for managing the liquid container 10b to the management device 40b. The information for managing the liquid container 10b is, for example, the update information of the control program, the update information of the management program, and the like. The cloud server 50 transmits information for managing the liquid container 10b to the management device 40b at a predetermined timing. The predetermined timing may be, for example, a timing at which information for managing the liquid container 10b is updated. The predetermined timing may be a predetermined time. Further, the predetermined timing may be other timings.

According to the management system 100b with such a configuration, the same effect as that of the second embodiment can be obtained. Further, it is possible to easily recognize the information of the liquid container 10b in each shop.

### Modified Embodiment

The liquid container 10b and the management device 40b of the third embodiment may be modified similarly to the second embodiment.

In the embodiment, a configuration of accessing the cloud server 50 by the management device 40b has been described, but a configuration of accessing the cloud server from another communication device may be used. In the case of accessing the cloud server from another communication device, the cloud server 50 may perform authentication using a user ID and a password registered in advance and may allow access to only the authenticated communication device.

With such a configuration, since it is possible to check the state of the liquid container 10b even in another communication device, it is possible to check the usage state from a remote place. For example, when the liquid container 10b is a beverage container used for sports, parents can check a beverage acquisition state during a child's exercise. Further, when the liquid container 10b is a personal portable beverage container, caregivers can check the beverage acquisition state by elderly people in a private room at a care facility. Further, when the liquid container 10b is a desktop pot, relatives can check the usage state by the elderly people living alone.

The liquid container 10b and the management device 40b may acquire the information (for example, any one or both of the temperature information and the first specified range information) used for the abnormality determination of any one or both of the first temperature sensor 32 and the second temperature sensor 36 from the cloud server 50 and may perform the abnormality determination of the first temperature sensor 32 and the second temperature sensor 36 on the basis of the acquired information. The information of the first specified range may be included in the notification information. The information may be recorded in the calculation processing unit 402. The information may be acquired from a memory. Further, the information may be acquired from the cloud server 50.

### Fourth Embodiment

In a fourth embodiment, a configuration different from the liquid container will be described.

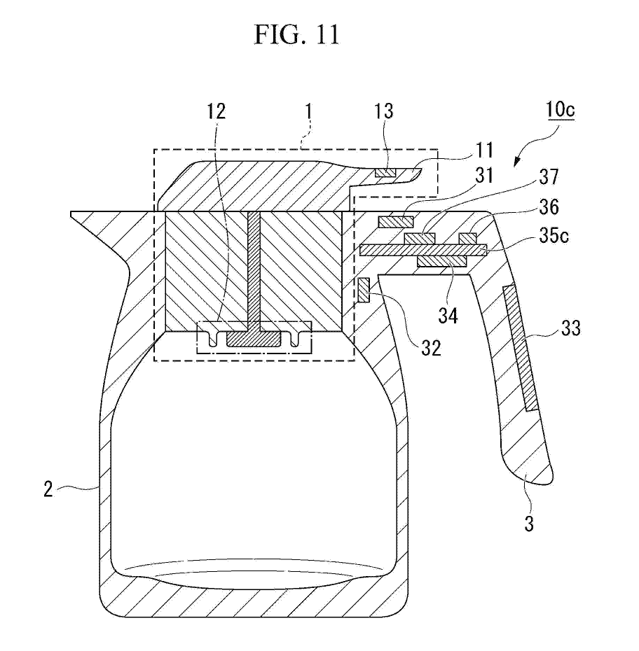

FIG. 11 is a diagram showing an example of a configuration of a liquid container 10c of the fourth embodiment.

The liquid container 10c is a container used to store beverages. For example, the liquid container 10c may be a pot such as a water bottle, a portable mug, a tumbler, a desktop pot, an electric kettle, and a coffee maker. FIG. 11 shows a case in which the liquid container 10c is a desktop pot.

The liquid container 10c includes the pouring cover 1 and the liquid container body 2. The configuration of the liquid container 10c is different from the configuration of the liquid container 10 shown in FIG. 1 in that an inclination sensor 37 is newly provided in the liquid container 10c and a control device 35c is provided in the grip 3 instead of the control device 35. Hereinafter, only the differences will be described.

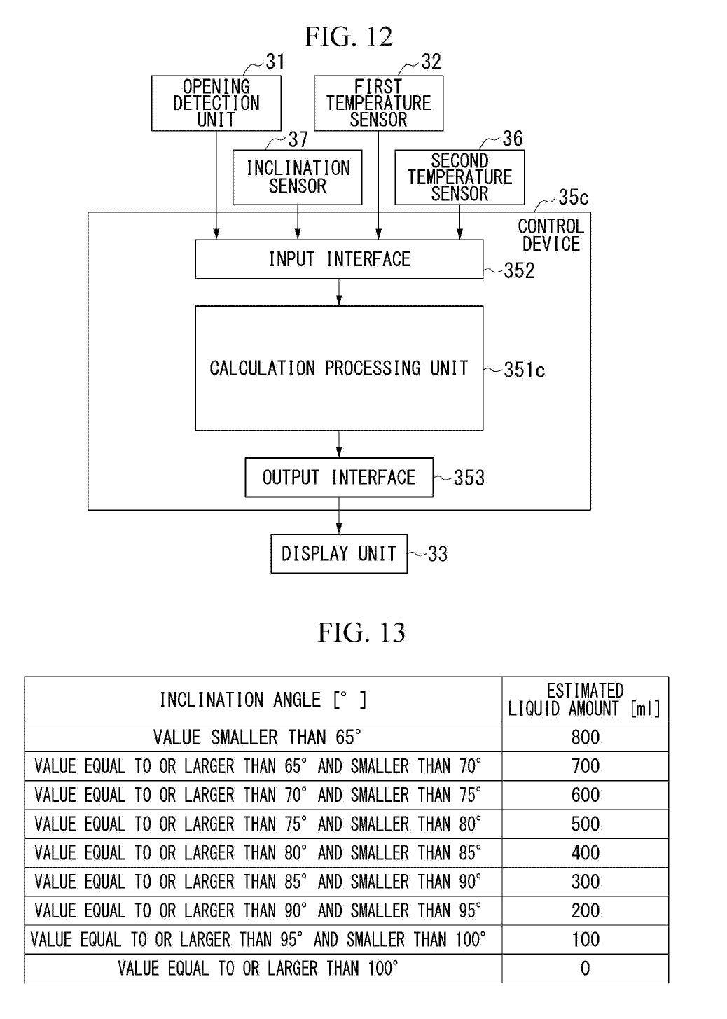

The inclination sensor 37 (the inclination angle measurement unit) is, for example, a three-axis acceleration sensor. The inclination sensor 37 measures an inclination angle of the liquid container 10c. The inclination sensor 37 outputs the measurement result corresponding to inclination angle information to a calculation processing unit 351c in the control device 35c through the input interface 352 (see FIG. 12). Furthermore, the inclination sensor 37 is not limited to the three-axis acceleration sensor and may be any sensor as long as the sensor can measure the inclination angle of the liquid container 10c.

FIG. 12 is a schematic block diagram showing a functional configuration of the control device 35c of the fourth embodiment. The control device 35c includes the calculation processing unit 351c equipped with a CPU or a memory and serves as a device which performs input/output control, a liquid amount estimation, a liquid amount warning, a liquid temperature estimation, a liquid temperature warning, and the like by the execution of the control program. Furthermore, all or a part of the functions of the control device 35c may be realized by using hardware such as ASIC, PLD, or FPGA. Further, the control program may be recorded in a computer readable recording medium. The computer readable recording medium is, for example, a recording device corresponding to a portable medium such as an SD card and a USB and a hard disk built in a computer system. Further, the control program may be transmitted and received through an electric communication line.

The control device 35c is different from the control device 35 in that the calculation processing unit 351c is provided and a liquid amount estimation program and a liquid amount warning program are newly provided in the control program. The other configurations of the control device 35c are the same as those of the control device 35. For that reason, a description of the entire control device 35c will be omitted.

The calculation processing unit 351c performs the same process as that of the calculation processing unit 351. Further, the calculation processing unit 351c in the control device 35c estimates the liquid amount inside the liquid container body 2 when an operation of discharging a liquid (hereinafter, referred to as a “liquid discharge operation”) has been performed and displays the estimation result on the display unit 33. Specifically, the calculation processing unit 351c determines whether the liquid discharge operation has been performed on the basis of the opening detection information of the opening detection unit 31. Then, when the liquid discharge operation is performed, the calculation processing unit 351c estimates the liquid amount inside the liquid container body 2 on the basis of the inclination angle information output from the inclination sensor 37 and displays the estimation result on the display unit 33. Further, the calculation processing unit 351c performs an information input/output by executing the input/output control program. For example, the calculation processing unit 351c inputs the opening detection information and the inclination angle information. The calculation processing unit 351c acquires the opening detection information through the input interface 352 and detects the opening of the discharge valve 12 on the basis of the acquired opening detection information.

The calculation processing unit 351c estimates the liquid amount inside the liquid container body 2 by executing the liquid amount estimation program. The liquid amount estimation program is a program for estimating the liquid amount inside the liquid container body 2 using the calculation processing unit. The calculation processing unit 351c acquires the inclination angle information through the input interface 352 and estimates the liquid amount inside the liquid container body 2 by using the acquired inclination angle information and a liquid amount estimation table. The liquid amount estimation table is a table in which the value of the liquid amount corresponding to the inclination angle is registered.

FIG. 13 is a diagram showing a detailed example of the liquid amount estimation table. The liquid amount estimation table includes a plurality of records (hereinafter, simply referred to as a “record”) showing a relationship between the inclination angle and the liquid amount. The record includes each value of the inclination angle and the estimated liquid amount. The value of the inclination angle indicates the inclination angle of the liquid container 10c. The value of the estimated liquid amount indicates the liquid amount (ml) estimated as a residual amount inside the liquid container body 2. In FIG. 13, in the record registered at the uppermost row of the liquid amount estimation table, the value of the inclination angle is smaller than “65°” and the value of the estimated liquid amount is “800”. That is, when the inclination angle of the liquid container 10c is smaller than “65°”, the calculation processing unit 351c estimates that the liquid amount inside the liquid container body 2 is “800 ml”. The liquid amount estimation table is recorded in a memory or the like.

Returning to FIG. 12, a description of the control device 35c will be continued.

The calculation processing unit 351c determines whether the estimated liquid amount value is smaller than the liquid amount set value. The liquid amount set value may be set in advance or may be changed periodically. The calculation processing unit 351c controls the display of the display unit 33 through the output interface 353 on the basis of the determination result.

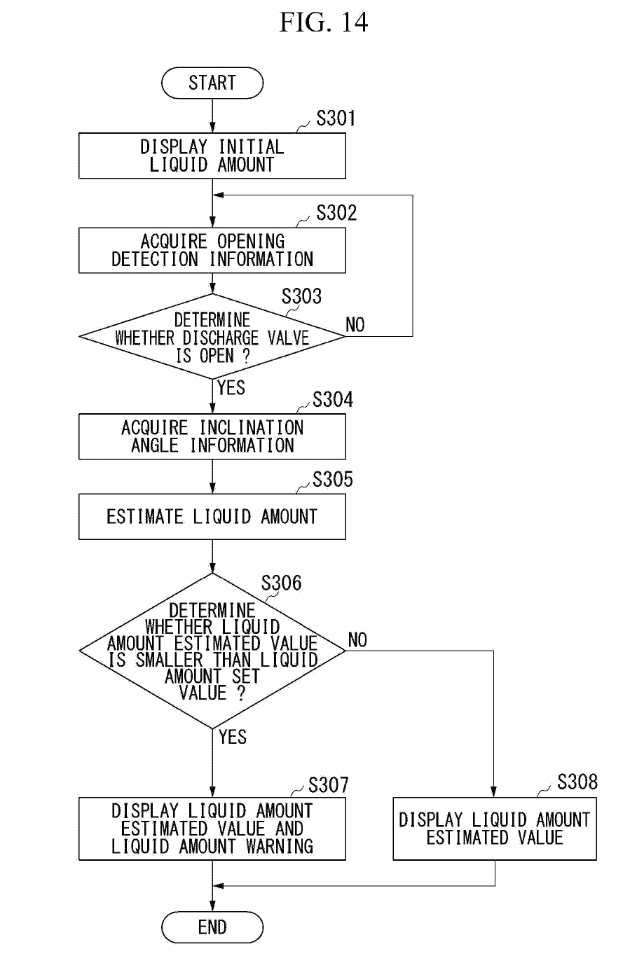

FIG. 14 is a flowchart showing a flow of a process of the liquid container 10c of the fourth embodiment. Furthermore, since the liquid temperature estimation process and the liquid temperature warning process are the same as those of the first embodiment, a description thereof will be omitted.

The display unit 33 displays an initial liquid amount after the liquid is injected into the liquid container 10c (step S301). The initial liquid amount may be a predetermined value or may be changed by a switch operation or the like.

The calculation processing unit 351c may display the initial liquid amount on the display unit 33 when a start switch (not shown) is pressed down after the liquid is injected into the liquid container 10c. The calculation processing unit 351 may display the initial liquid amount on the display unit 33 when the liquid is injected into the liquid container 10c, the temperature around the inside of the liquid container 10c is detected by the temperature sensor. Further, when the display unit 33 is a touch panel, the initial liquid amount may be displayed on the display unit 33 after a display instruction to the display unit 33 is made.

The calculation processing unit 351c acquires the opening detection information from the opening detection unit 31 through the input interface 352 (step S302). Then, the calculation processing unit 351c determines whether the discharge valve 12 is open on the basis of the acquired opening detection information (step S303). For example, when the value indicating the strength of the magnetic field included in the opening detection information is equal to or larger than the threshold value, the calculation processing unit 351c determines that the discharge valve 12 is open.

Meanwhile, when the value indicating the strength of the magnetic field included in the opening detection information is smaller than the threshold value, the calculation processing unit 351c determines that the discharge valve 12 is not opened.

In the process of step S303, when it is determined that the discharge valve 12 is not opened (step S303—NO), the process of step S302 and step S303 is repeated until the opening of the discharge valve 12 is determined.

In the process of step S303, when it is determined that the discharge valve 12 is open (step S303—YES), the calculation processing unit 351c determines that the liquid discharge operation has been performed. In this case, the calculation processing unit 351c acquires the inclination angle information from the inclination sensor 37 through the input interface 352 (step S304). Furthermore, the calculation processing unit 351c acquires the inclination angle information from the inclination sensor 37 while the discharge valve 12 is open.

The calculation processing unit 351c estimates the liquid amount inside the liquid container body 2 on the basis of the acquired inclination angle information and the liquid amount estimation table (step S305). Specifically, the calculation processing unit 351c first selects a record corresponding to the angle indicated by the inclination angle information from a record registered in the liquid amount estimation table. Then, the calculation processing unit 351c acquires a value of the item of the estimated liquid amount of the selected record. The calculation processing unit 351c sets the acquired value to the liquid amount estimated value inside the liquid container body 2.

Furthermore, when there are a plurality of inclination angle information acquired while the discharge valve 12 is open, the calculation processing unit 351c may estimate the liquid amount by using the last acquired inclination angle information. The liquid amount may be estimated by using an average value of the inclination angles indicated by the inclination angle information acquired while the discharge valve 12 is open. Further, the liquid amount may be estimated by using a maximum inclination angle indicated by the inclination angle information acquired while the discharge valve 12 is open.

The calculation processing unit 351c determines whether the liquid amount estimated value is smaller than the liquid amount set value (step S306). When the liquid amount estimated value is smaller than the liquid amount set value (step S306—YES), the calculation processing unit 351c displays the liquid amount estimated value and the liquid amount warning on the display unit 33 by executing the liquid amount warning program (step S307). The liquid amount warning program is a program for notifying a warning for the liquid amount to the calculation processing unit. The liquid amount warning is, for example, information indicating that the liquid amount is small.

Furthermore, the calculation processing unit 351c may display the liquid amount estimated value and the liquid amount warning on the display unit 33 in any manner. For example, the calculation processing unit 351c may display the liquid amount estimated value as a graph and display the liquid amount warning as letters. The liquid amount estimated value may be displayed as a number and the liquid amount warning may be displayed as letters. Further, another display may be used.

Meanwhile, when the liquid amount estimated value is not smaller than the liquid amount set value (step S306—NO), the calculation processing unit 351c displays the liquid amount estimated value on the display unit 33 (step S308). Furthermore, the calculation processing unit 351c may display the liquid amount estimated value on the display unit 33 in any manner.

For example, the calculation processing unit 351c may display the liquid amount estimated value as a graph. The liquid amount estimated value may be displayed as a number. Further, other display may be used.

According to the liquid container 10c with such a configuration, the same effect as that of the first embodiment can be obtained.

Further, the liquid container 10c can improve convenience while considering sanitation. Specifically, the liquid container 10c estimates the liquid amount from the inclination angle information of the liquid container 10c and displays information on the liquid amount on the basis of the estimated liquid amount. Thus, the user can easily recognize the liquid amount inside the liquid container 10c without separating the pouring cover 1 therefrom. Accordingly, the user can determine whether to replace the liquid inside the liquid container 10c in response to the liquid amount. Further, the sensor may not be in direct contact with the liquid in order to estimate the liquid amount. Thus, it is sanitary. For that reason, it is possible to improve convenience while considering sanitation.

Further, the liquid container 10c acquires information from the inclination sensor 37 at the timing when the discharge valve 12 opens and estimates the liquid amount. Thus, since the liquid container 10c acquires information from the inclination sensor 37 only when the discharge operation is performed and estimates the liquid amount, it is possible to reduce a process load and limit power consumption.

Further, the liquid container 10c warns that the liquid amount is small in addition to the information of the liquid amount estimated value when the liquid amount estimated value is smaller than the liquid amount set value. Accordingly, the liquid container 10c can notify the user of a state in which the liquid inside the liquid container body 2 needs to be replaced. For that reason, convenience can be improved.

Further, the liquid container 10c estimates the liquid amount and displays the liquid amount on the display unit 33. For that reason, the user can recognize the liquid amount without opening the pouring cover 1 in the opaque container.

Further, all function units that display a liquid amount by estimation are provided in the grip 3. For that reason, even when a malfunction occurs due to a failure or the like, a repair or replacement becomes easy.

Further, the opening detection unit 31 and the inclination sensor 37 are attached to a position not contacting the liquid in a normal usage state. For that reason, staining of the opening detection unit 31 and the inclination sensor 37 with the liquid and thermal deterioration of the resin accommodating the sensor are difficult. Further, since the opening detection unit 31 and the inclination sensor 37 do not protrude into the liquid container body 2, these members can be easily cleaned. Further, the opening detection unit 31, the inclination sensor 37, the display unit 33, and the control device 35c can be accommodated in a compact size.

### Modified Embodiment

The fourth embodiment may be modified similarly to the first embodiment.

When the liquid amount estimated value is smaller than the liquid amount set value, the liquid container 10c may display a warning that the liquid amount estimated value is smaller than the liquid amount set value and notify the user about the corresponding liquid container 10c in a notification mode different from that of the display. The notification mode different from the display may be a notification by an alarm. It may be a notification by light emission. It may be a notification by sound notification. Furthermore, other notifications may be used.

In the embodiment, a configuration in which the calculation processing unit 351c determines whether the liquid discharge operation has been performed on the basis of the opening and closing of the discharge valve 12 has been described, but the calculation processing unit 351c may determine whether the liquid discharge operation has been performed by a different method. For example, the calculation processing unit 351c determines that the liquid discharge operation has been performed when determining that the liquid container body 2 is gripped or the grip 3 is gripped. A method of determining that the liquid container body 2 is gripped or the grip 3 is gripped can be realized by using a touch sensor. For example, if a touch sensor is provided at the grip 3 or a predetermined place outside the liquid container body 2, it is determined that the liquid container body 2 is gripped or the grip 3 is gripped when the calculation processing unit 351c acquires a detection signal from the touch sensor.

Further, the calculation processing unit 351c performs an abnormality determination corresponding to the liquid temperature estimated value as below. Specifically, the calculation processing unit 351c stores a time at which the opening of the discharge valve 12 is detected and the temperature information and the liquid amount information obtained when the opening of the discharge valve 12 is detected at the time point and calculates a change in liquid temperature per unit time (that is, a liquid temperature change rate) on the basis of a time from a preceding timing of detecting the opening of the discharge valve 12 to a new timing of detecting the opening of the discharge valve 12 and a difference in liquid amount estimated value and a difference in liquid temperature estimated value for that time. Next, the calculation processing unit 351c compares the calculated liquid temperature change rate and a predetermined liquid temperature change rate with each other. Then, the calculation processing unit 351c determines whether the heat insulating performance of the liquid container 10c is maintained on the basis of the comparison result.

Since a determination on whether the heat insulating performance is maintained has been described above, a description thereof will be omitted. Furthermore, the calculation processing unit 351c may acquire the temperature information and the liquid amount information at an arbitrary timing instead of the timing of detecting the opening of the discharge valve 12.

The calculation processing unit 351c may be configured to determine whether the inclination angle value indicated by the inclination angle information acquired from the inclination sensor 37 is within a second specified range. The second specified range is a determination reference for determining whether the inclination sensor 37 has a failure and is, for example, 0 to 180°. Furthermore, the second specified range is not limited to the above-described range and may be set appropriately. The information of the second specified range may be recorded in the calculation processing unit 351c or may be acquired from a memory. The calculation processing unit 351c determines that the inclination sensor 37 is normal when the value of the inclination angle indicated by the inclination angle information is inside the second specified range and determines that the inclination sensor 37 has an abnormality (failure) when the value of the inclination angle indicated by the inclination angle information is outside the second specified range. When the value of the inclination angle indicated by the inclination angle information is outside the second specified range, the calculation processing unit 351c may display the possibility that the inclination sensor 37 has a failure on the display unit 33.

Further, the calculation processing unit 351c may be configured to shift to the power saving mode when the opening state of the discharge valve 12 is not detected. In the case of the fourth embodiment, the calculation processing unit 351c limits the operation of acquiring the inclination angle information when the opening of the discharge valve 12 is not detected. Specifically, the calculation processing unit 351c stops the supply of power for operating the inclination sensor 37 when the opening of the discharge valve 12 is not detected. Then, when the opening of the discharge valve 12 is detected again, the calculation processing unit 351c supplies power to the inclination sensor 37 and activates the inclination sensor 37 so that a power saving mode is shifted to a normal mode.

With such a configuration, the inclination sensor 37 cannot acquire the inclination angle information until the opening of the discharge valve 12 is detected. For that reason, it is possible to limit power consumption.

In the embodiment, a configuration in which the calculation processing unit 351c estimates the liquid amount by using the liquid amount estimation table is shown. However, there is a case in which an error between the actual liquid amount and the liquid amount estimated by using the liquid amount estimation table increases in accordance with the type of the liquid container 10c. For example, in the liquid container 10c which does not have a lid or has a large discharge port and the liquid container 10c which limits the discharge flow rate by the size of the discharge port, a correlation between the liquid amount (residual amount) and the inclination angle of the liquid container 10c is different.

As the liquid container 10c which does not have a lid or has a large discharge port, a pitcher, a tumbler, a desktop mug, and the like are exemplary examples. As the liquid container 10c which limits the discharge flow rate by the size of the discharge port, a container having a small discharge port such as a desktop pot and a portable mug is an exemplary example. In the liquid container 10c which does not have a lid or has a large discharge port, since the liquid container body 2 is not greatly inclined during the discharge operation, a correlation between the inclination angle and the liquid amount (residual amount) of the liquid container body 2 is strong. In contrast, since the liquid container 10c which limits the discharge flow rate by the size of the discharge port has a possibility that the inclination angle may increase during the discharge operation, a correlation between the inclination angle and the liquid amount (residual amount) of the liquid container body 2 is weak.

For that reason, when the liquid amount is estimated by using the same liquid amount estimation table in any liquid container 10c, a possibility that an error between the estimated liquid amount and the actual liquid amount in the liquid container 10c having a weak correlation increases. Therefore, the calculation processing unit 351 estimates the liquid amount by using the liquid amount estimation table in the liquid container 10c which does not have a lid or has a large discharge port. In contrast, the calculation processing unit 351 estimates the liquid amount after correcting the inclination angle on the basis of the upper limit of the discharge amount in the liquid container 10c which limits the discharge flow rate by the size of the discharge port. Hereinafter, a method of estimating the liquid amount after correcting the inclination angle on the basis of the upper limit of the discharge amount will be described.

(Test Procedure)
The inclination angle of the liquid container 10c is gently changed to discharge the liquid and the liquid amount estimation table is created.
The inclination angle of the liquid container 10c is extremely increased to discharge the liquid, the maximum discharge amount is measured, and the maximum discharge amount per unit time is obtained.
The maximum discharge amount per unit time is converted into a change in inclination angle per unit time. This value is referred to as an “allowable angle change rate.”
A time point of exceeding the inclination angle corresponding to the estimated liquid amount before the discharge operation is defined as a start point and the sum of the allowable angle change rate multiplied by the discharge operation time from the start point and the inclination angle corresponding to the estimated liquid amount before the discharge operation is defined as an “allowable angle.”
A program using the allowable angle change rate is created, for example, as below. In the liquid amount estimation table, the “acquired inclination angle information” is replaced by the “allowable angle” when the “acquired inclination angle information” is larger than the “allowable angle” in a range which is larger than the inclination angle corresponding to the estimated liquid amount before the discharge operation.
“Correction inclination angle” is the small one of “acquired inclination angle information” and “allowable angle”
The liquid amount is estimated by comparing the maximum value of the “correction inclination angle” during the discharge operation with the liquid amount estimation table.

Furthermore, a condition or a calculation method of the liquid amount estimation table, the allowable angle change rate, and the allowable angle is not limited to the description above and may be adjusted so that a difference between the actual discharge amount and the estimated liquid amount becomes minimal.

Next, when the estimated amount of the liquid is 600 ml, the test data when discharging the liquid until 300 ml is left is shown below.
The pot capacity is 1000 ml.
The liquid amount estimated value before the discharge operation is 600 ml.
The liquid amount estimation table is used (FIG. 13).
The maximum discharge amount of 60 ml/second per unit time is converted to the allowable angle change rate of 3°/second
The correction by the allowable angle change rate is performed from a time point at which the inclination angle exceeds the lower limit (70°) of the inclination angle corresponding to the estimated liquid amount (600 ml) before the discharge operation.

(Discharge Example at Large Inclination Angle of Liquid Container 10c)

In a case in which the calculation processing unit 351c estimates the liquid amount only from the liquid amount estimation table, the inclination angle is 98° and the estimated liquid amount is 100 ml.

In a case in which the calculation processing unit 351c estimates the liquid amount by the correction inclination angle, the inclination angle is 85° and the estimated liquid amount is 300 ml.

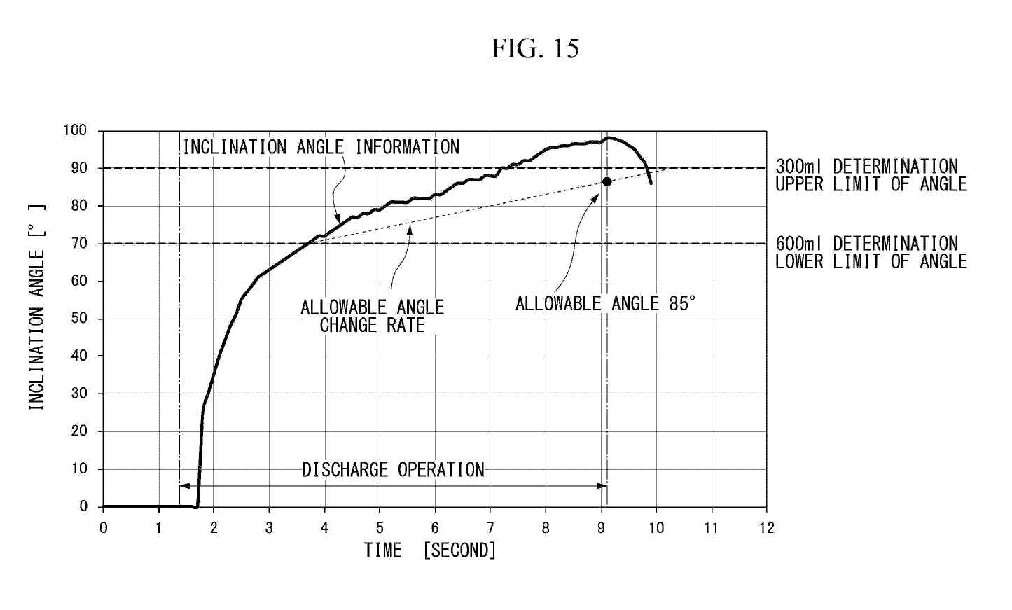

The above-described result is shown in FIG. 15. FIG. 15 is a diagram showing a test example in a case in which the liquid amount is estimated by correction. As shown in FIG. 15, the maximum inclination angle at the time point of performing the discharge operation is 98°, but the inclination angle used to estimate the actual liquid amount in consideration of the allowable angle change rate is 85°. By performing such a process, the liquid amount can be estimated with higher accuracy.

### Fifth Embodiment

In a fifth embodiment, a first example of a system to which the liquid container of the fourth embodiment is applied will be described.

A management system 100d of the fifth embodiment is applied to, for example, a restaurant and a game hall including a food space. The management system 100d includes a liquid container 10d and a management device 40d.

The liquid container 10d includes the pouring cover 1 and the liquid container body 2. The configuration of the liquid container 10d is different from that of the liquid container 10c in that the liquid container body 2 includes a control device 35d instead of the control device 35c and does not include the display unit 33. The other configurations of the liquid container 10d are the same as those of the liquid container 10c. For that reason, a description of the entire liquid container 10d will be omitted. The control device 35d transmits the inclination angle information and the temperature information to the management device 40d.

The management device 40d is configured as, for example, an information processing device such as a smart phone, a mobile phone, a tablet terminal, a notebook computer, and a personal computer. The management device 40d manages the liquid container 10d. For example, the management device 40d estimates the liquid amount inside the liquid container body 2 of each liquid container 10d on the basis of the inclination angle information transmitted from the liquid container 10d and displays the liquid amount estimated value or the liquid amount warning of each liquid container 10d. Further, for example, the management device 40d estimates the liquid temperature inside the liquid container body 2 of each liquid container 10d on the basis of the temperature information transmitted from the liquid container 10d and displays the liquid temperature estimated value or the liquid temperature warning of each liquid container 10d.

The management system 100d includes one or plural liquid containers 10d. The liquid container 10d and the management device 40d perform wireless communication by Bluetooth (trademark). In the description below, an example of a case in which the management system 100d is applied to a restaurant will be described. In this case, it is assumed that the liquid container 10d is provided at each table.

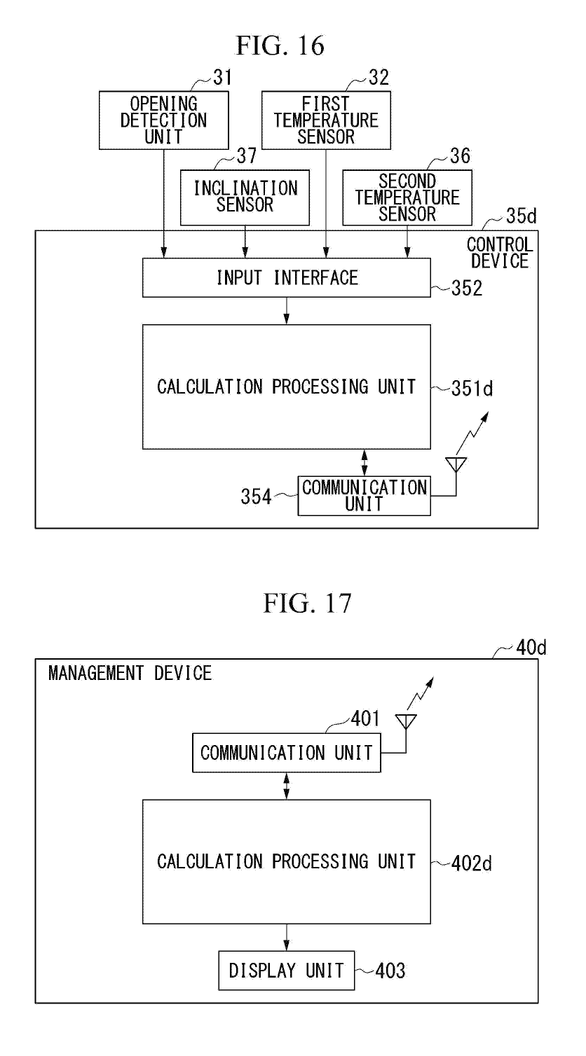

FIG. 16 is a schematic block diagram showing a functional configuration of the control device 35d of the fifth embodiment. The control device 35d includes a communication unit 354 and a calculation processing unit 351d equipped with a CPU or a memory and serves as a device that performs input/output control by the execution of the control program. Furthermore, all or a part of the functions of the control device 35d may be realized by using hardware such as ASIC, PLD, or FPGA. Further, the control program may be recorded in a computer readable recording medium. The computer readable recording medium is, for example, a recording device such as an SD card, a portable medium such as a USB, and a hard disk built in a computer system. Further, the control program may be transmitted and received through an electric communication line.

The configuration of the control device 35d is different from that of the control device 35c in that the communication unit 354 is newly provided and the calculation processing unit 351d does not execute the liquid amount estimation program, the liquid amount warning program, the liquid temperature estimation program, and the liquid temperature warning program. The other configurations of the control device 35d are the same as those of the control device 35c. For that reason, a description of the entire control device 35d will be omitted.

The calculation processing unit 351d performs an information input/output by the execution of the input/output control program. For example, the calculation processing unit 351d inputs the opening detection information, the inclination angle information, the inner temperature information, and the outer temperature information. The calculation processing unit 351d acquires the opening detection information through the input interface 352 and detects the opening of the discharge valve 12 on the basis of the acquired opening detection information. Then, when the opening of the discharge valve 12 is detected, the calculation processing unit 351d acquires the inclination angle information through the input interface 352 and transmits the acquired inclination angle information to the management device 40d. Further, the calculation processing unit 351d acquires the temperature information (the inner temperature information and the outer temperature information) through the input interface 352 and transmits the acquired temperature information to the management device 40d.

The communication unit 354 communicates with the management device 40d. For example, the communication unit 354 correlates the inclination angle information acquired through the input interface 352 and the liquid container ID and transmits them to the management device 40d as the notification information. Further, for example, the communication unit 354 correlates the temperature information acquired through the input interface 352 and the liquid container ID and transmits them to the management device 40d as the notification information.

FIG. 17 is a schematic block diagram showing a functional configuration of the management device 40d of the fifth embodiment. The management device 40d includes the communication unit 401, a calculation processing unit 402d, and the display unit 403 and serves as a device which performs input/output control, a liquid amount estimation, a liquid amount warning, a total liquid amount management, a liquid temperature estimation, and a liquid temperature warning by the execution of the management program. Furthermore, all or a part of the functions of the management device 40d may be realized by using hardware such as ASIC, PLD, or FPGA. Further, the management program may be recorded in a computer readable recording medium. The computer readable recording medium is, for example, a recording device corresponding to a flexible disk, a magneto-optical disk, a portable medium such as a ROM and a CD-ROM, and a hard disk built in a computer system. Further, the management program may be transmitted and received through an electric communication line.

The management device 40d is different from the management device 40 in that the calculation processing unit 402d is provided and the liquid temperature estimation program and the liquid temperature warning program are newly provided in the management program. The other configurations are the same as those of the management device 40. For that reason, a description of the entire management device 40d will be omitted.

The calculation processing unit 402d performs the same process as that of the calculation processing unit 402 of the second embodiment. The calculation processing unit 402d estimates the liquid temperature inside the liquid container body 2 of each liquid container 10d by executing the liquid temperature estimation program using the notification information received by the communication unit 401. The calculation processing unit 402d determines whether the liquid temperature estimated value estimated by the liquid temperature warning program is smaller than the liquid temperature set value. The calculation processing unit 402d controls the display of the display unit 403 on the basis of the determination result.

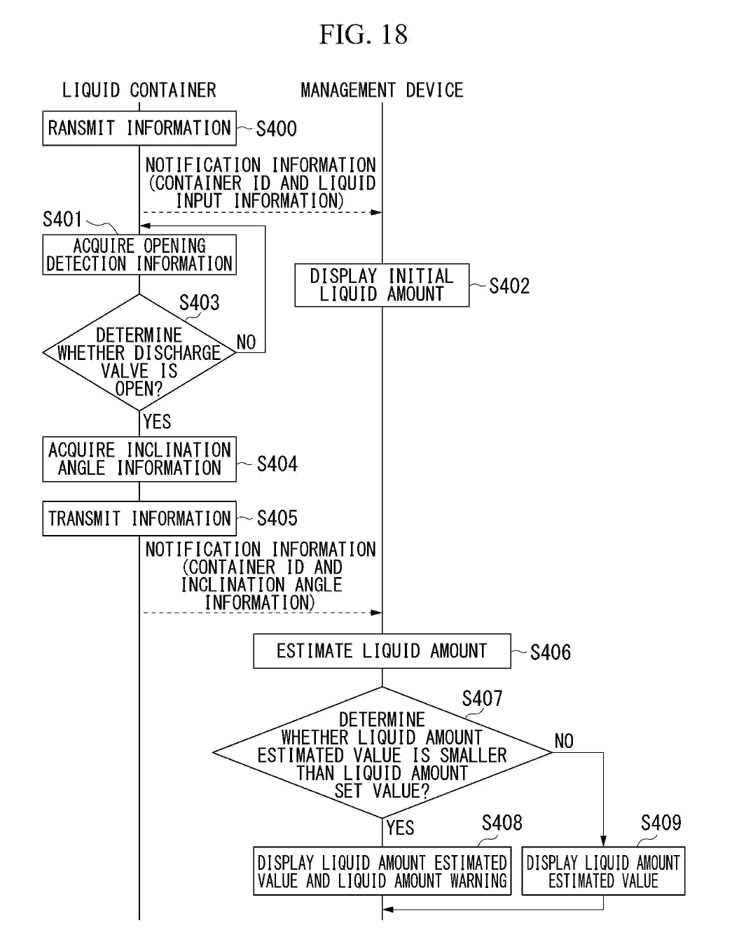

FIG. 18 is a sequence diagram showing a flow of the liquid amount estimation process and the liquid amount warning process of the management system 100d of the fifth embodiment. Furthermore, in the description of FIG. 18, a case in which one liquid container 10d and one management device 40d are provided will be described as an example for simplicity. Further, since the liquid temperature estimation process and the liquid temperature warning process are the same as those of the second embodiment, a description thereof will be omitted.

The communication unit 354 of the liquid container 10d transmits the notification information including information indicating the input of the liquid and the liquid container ID to the management device 40d (step S400). For example, the communication unit 354 may transmit the notification information to the management device 40d at a timing at which an instruction of transmitting the information of the input of the liquid is generated from the calculation processing unit 351d. The communication unit 401 of the management device 40d receives the notification information transmitted from the liquid container 10d.

The calculation processing unit 351d acquires the opening detection information from the opening detection unit 31 through the input interface 352 (step S401).

The display unit 403 of the management device 40d displays the initial liquid amount of each liquid container 10d (step S402). The initial liquid amount may be a predetermined value or may be changed by a switch operation or the like. The calculation processing unit 402d may display the initial liquid amount on the display unit 403 when the notification information including the information indicating the input of the liquid is received. When the display unit 403 is a touch panel, the initial liquid amount may be displayed on the display unit 403 after a display instruction to the display unit 403 is made.

The calculation processing unit 351d determines whether the discharge valve 12 is open on the basis of the acquired opening detection information (step S403). When it is determined that the discharge valve 12 is not opened (step S403—NO), the processes of step S401 and step S403 are repeated until it is determined that the discharge valve 12 is open.

Meanwhile, when it is determined that the discharge valve 12 is open (step S403—YES), the calculation processing unit 351d determines that the liquid discharge operation has been performed. In this case, the calculation processing unit 351d acquires the inclination angle information from the inclination sensor 37 through the input interface 352 (step S404). Furthermore, the calculation processing unit 351d acquires the inclination angle information from the inclination sensor 37 while the discharge valve 12 is open.

The calculation processing unit 351d controls the communication unit 354, correlates the inclination angle information and the liquid container ID, and transmits them to the management device 40d as the notification information (step S405). Furthermore, when there are a plurality of inclination angle information acquired while the discharge valve 12 is open, the calculation processing unit 351d may transmit only the last acquired inclination angle information. All inclination angle information acquired while the discharge valve 12 is open may be transmitted. An average value of the inclination angle indicated by the acquired inclination angle information may be transmitted. Further, a maximum inclination angle indicated by the inclination angle information included in the acquired information may be transmitted.

The communication unit 401 of the management device 40d receives the notification information transmitted from the liquid container 10d. The calculation processing unit 402d estimates the liquid amount inside the liquid container body 2 of the liquid container 10d on the basis of the inclination angle information included in the notification information received by the communication unit 401 and the liquid amount estimation table (step S406).

Furthermore, when there are a plurality of inclination angle information included in the notification information, the calculation processing unit 402d may estimate the liquid amount by using the last acquired inclination angle information. The liquid amount may be estimated by using an average value of the inclination angle indicated by the inclination angle information included in the notification information. Further, the liquid amount may be estimated by using a maximum inclination angle indicated by the inclination angle information included in the notification information.

Further, an example in which one liquid container 10d is provided has been described in FIG. 18, but the calculation processing unit 402d estimates the liquid amount inside the liquid container body 2 of each liquid container 10d when the notification information is received from the liquid containers 10d. Since the liquid amount estimation method is the same as the estimation method of the calculation processing unit 351c, a description thereof will be omitted.

The calculation processing unit 402d determines whether the liquid amount estimated value is smaller than the liquid amount set value (step S407). When the liquid amount estimated value is smaller than the liquid amount set value (step S407—YES), the calculation processing unit 402d displays the liquid amount estimated value and the liquid amount warning on the display unit 403 by executing the liquid amount warning program (step S408).

Furthermore, the calculation processing unit 402d may display the liquid amount estimated value and the liquid amount warning on the display unit 403 in any manner. For example, the calculation processing unit 402d may display the liquid amount estimated value as a graph and display the liquid amount warning as letters. The liquid amount estimated value may be displayed as a number and the liquid amount warning may be displayed as letters. Further, another display may be used.

Meanwhile, when the liquid amount estimated value is not smaller than the liquid amount set value (step S407—NO), the calculation processing unit 402d displays the liquid amount estimated value on the display unit 403 (step S409). Furthermore, the calculation processing unit 402d may display the liquid amount estimated value on the display unit 403 in any manner. For example, the calculation processing unit 402 may display the liquid amount estimated value as a graph. The liquid amount estimated value may be displayed as a number. Further, another display may be used.

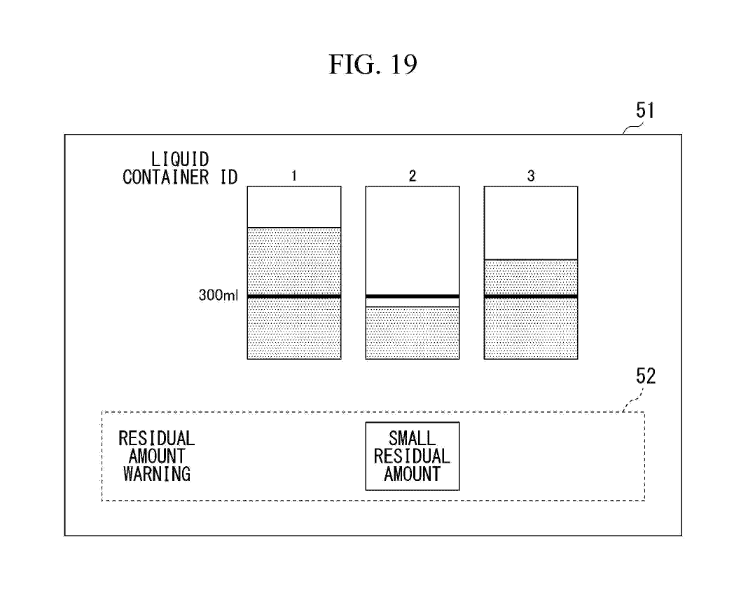

A display example in which a plurality of liquid containers 10d are provided in the management device 40d will be described with reference to FIG. 19. FIG. 19 is a diagram showing a display example of the display unit 403 of the management device 40d of the fifth embodiment. As shown in FIG. 19, the display unit 403 displays the same image as the image 51. FIG. 19 shows a case in which three liquid containers 10d are provided. Further, a warning is displayed on the warning display region 52 for the liquid container 10d having a liquid amount warning. In FIG. 19, a state in which the remaining amount of the liquid container 10d identified as the liquid container ID “2” is small is displayed as a warning. Furthermore, the display example is not limited to such a display.

According to the management system 100d with such a configuration, the same effect as that of the second embodiment can be obtained. Further, the liquid container 10d and the management device 40d display the liquid amount estimated value inside the liquid container body 2 in addition to the liquid temperature. Accordingly, new information can be provided for the user. For that reason, convenience can be improved.

### Modified Embodiment

The liquid container 10d and the management device 40d of the fifth embodiment may be modified similarly to the liquid container 10a and the management device 40 of the second embodiment.

Similar to the calculation processing unit 402 of the second embodiment, the calculation processing unit 402d may be configured to determine the abnormality (failure) of the first temperature sensor 32 and the second temperature sensor 36.

In the case of such a configuration, the calculation processing unit 402d may display the possibility that any one or both of the first temperature sensor 32 and the second temperature sensor 36 has a failure on any one or both of the display unit 33 and the display unit 403.

Further, similar to the calculation processing unit 351c of the fourth embodiment, the calculation processing unit 402d may be configured to determine whether the inclination sensor 37 has a failure on the basis of the inclination angle information included in the notification information. In the case of such a configuration, the calculation processing unit 402d may display the possibility that the inclination sensor 37 has a failure when the value of the inclination angle indicated by the inclination angle information is outside the second specified range on any one or both of the display unit 33 and the display unit 403.

Further, the calculation processing unit 351d may be configured to shift to the power saving mode when the opening state of the discharge valve 12 is not detected. In the case of the fifth embodiment, the calculation processing unit 351d limits the operation of the inclination sensor 37 in addition to, for example, the first temperature sensor 32, the second temperature sensor 36, and the communication unit 354. Since the limitation of the operation for the first temperature sensor 32, the second temperature sensor 36, and the communication unit 354 is the same as that of the second embodiment, a description thereof will be omitted.

The calculation processing unit 351d stops the supply of power for operating the inclination sensor 37 when the opening of the discharge valve 12 is not detected. Then, when the calculation processing unit 351d detects the opening of the discharge valve 12, power is supplied to the inclination sensor 37 to activate the inclination sensor 37. With such a configuration, the inclination sensor 37 cannot acquire the inclination angle information until the opening of the discharge valve 12 is detected. For that reason, it is possible to limit power consumption.

Similar to the fourth embodiment, the liquid container 10d may be configured to display any one or all of the liquid amount estimated value, the liquid amount warning, the liquid temperature estimated value, and the liquid temperature warning. In the case of such a configuration, the liquid container 10d is configured to include an output interface 353 and a display unit 33 shown in FIG. 12. In the case of such a configuration, one of the following two configurations is adopted in the fifth embodiment.

A first configuration is set such that the liquid amount estimated value, the liquid amount warning, the liquid temperature estimated value, and the liquid temperature warning are not displayed in the liquid container 10d and any one or all of the liquid amount estimated value, the liquid amount warning, the liquid temperature estimated value, and the liquid temperature warning are displayed in the management device 40d.

A second configuration is set such that any one or all of the liquid amount estimated value, the liquid amount warning, the liquid temperature estimated value, and the liquid temperature warning are displayed in both the liquid container 10d and the management device 40d.

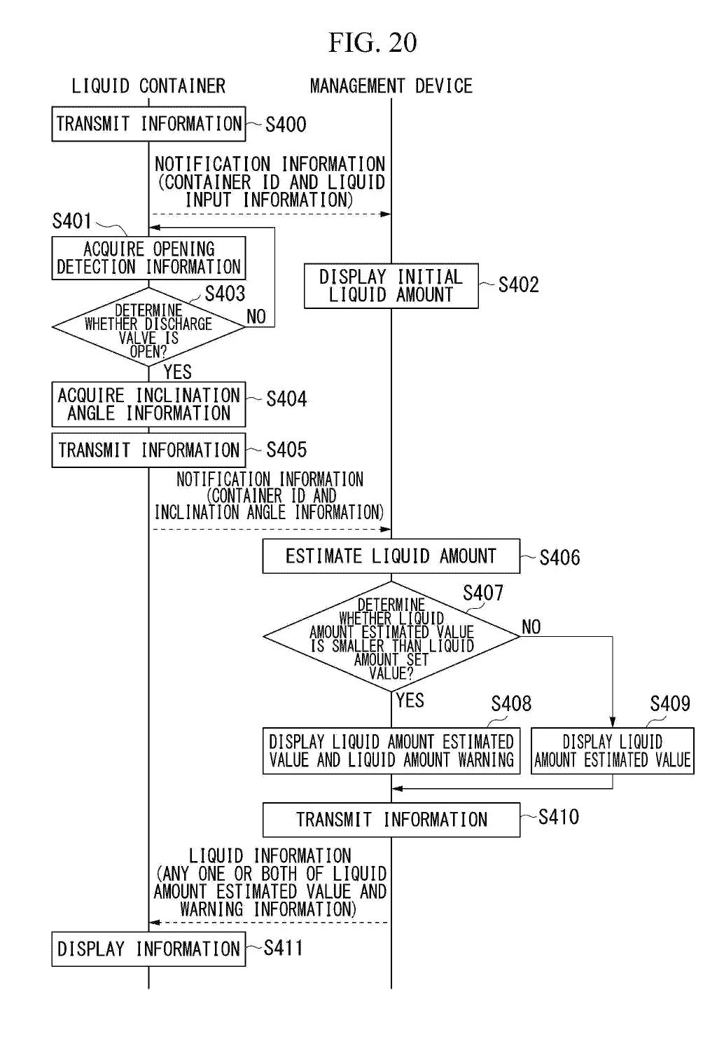

Since the first configuration has been described in the fifth embodiment, a description thereof will be omitted. Then, the second configuration will be described in detail below with reference to FIG. 20.

FIG. 20 is a sequence diagram showing a flow of an operation of the management system 100d of the modified embodiment of the fifth embodiment. In FIG. 20, since the same reference numerals as those of FIG. 18 are given to the same processes as those of FIG. 18, a description thereof will be omitted.

After the process of step S408 or step S409, when the management device 40d determines that the liquid temperature estimated value is smaller than the liquid temperature set value in the process of step S204 or the liquid amount estimated value is smaller than the liquid amount set value in the process of step S407, the liquid information, including the liquid amount estimated value, the liquid amount warning, the liquid temperature estimated value, and the liquid temperature warning, is transmitted to the liquid container 10d (step S410). Furthermore, when there are a plurality of liquid containers 10d, the management device 40d transmits the liquid information including the liquid amount estimated value, the liquid amount warning, the liquid temperature estimated value, and the liquid temperature warning to each liquid container 10d.

Meanwhile, when the management device 40d determines that the liquid temperature estimated value is equal to or larger than the liquid temperature set value in the process of step S204 or the liquid amount estimated value is equal to or larger than the liquid amount set value in the process of step S407, the liquid information including the liquid amount estimated value and the liquid temperature estimated value is transmitted to the liquid container 10d (step S410). Furthermore, when there are a plurality of liquid containers 10d, the management device 40d transmits the liquid information including the liquid amount estimated value and the liquid temperature estimated value to each liquid container 10d.

The liquid information transmitted from the management device 40d to the liquid container 10d may include all of the liquid amount estimated value, the liquid amount warning, the liquid temperature estimated value, and the liquid temperature warning. A combination of some of these may be used. Further, one of these may be used.

The calculation processing unit 351d of the liquid container 10d displays information included in the liquid information on the display unit 33 on the basis of the liquid information transmitted from the management device 40d (step S411). Specifically, the calculation processing unit 351d displays the liquid amount estimated value, the liquid amount warning, the liquid temperature estimated value, and the liquid temperature warning on the display unit 33 when the liquid amount estimated value, the liquid amount warning, the liquid temperature estimated value, and the liquid temperature warning are included in the liquid information transmitted from the management device 40d.

The calculation processing unit 351d displays the liquid amount estimated value on the display unit 33 when only the liquid amount estimated value is included in the liquid information transmitted from the management device 40d.

The calculation processing unit 351d displays the liquid amount estimated value and the liquid amount warning on the display unit 33 when the liquid amount estimated value and the liquid amount warning are included in the liquid information transmitted from the management device 40d.

The calculation processing unit 351d displays the liquid temperature estimated value on the display unit 33 when only the liquid temperature estimated value is included in the liquid information transmitted from the management device 40d.

The calculation processing unit 351d displays the liquid temperature estimated value and the liquid temperature warning on the display unit 33 when the liquid temperature estimated value and the liquid temperature warning are included in the liquid information transmitted from the management device 40d.

### Sixth Embodiment

In a sixth embodiment, a second example of a system to which the liquid container of the fourth embodiment is applied will be described.

A management system 100e of the sixth embodiment is applied to, for example, a restaurant and a game hall including a food space. The management system 100e has the same configuration as that of FIG. 10. A difference from FIG. 10 of the management system 100e is that a liquid container 10e is provided instead of the liquid container 10b and a management device 40e is provided instead of the management device 40b.

In the sixth embodiment, the inner configuration of the liquid container 10e is the same as that of the liquid container 10d of the fifth embodiment.

In the sixth embodiment, the inner configuration of the management device 40e is the same as that of the management device 40d of the fifth embodiment. The management device 40e is different from the management device 40d in that the liquid consumption amount for one day is transmitted to the cloud server 50 at a predetermined time (for example, 12 o'clock) and the information for managing the liquid container 10e and the result of aggregating or analyzing the information for each area are received from the cloud server 50. The information for managing the liquid container 10e is, for example, the update information of the liquid amount estimation table, the update information of the control program, the update information of the management program, and the like.

According to the management system 100e with such a configuration, the same effect as that of the fifth embodiment can be obtained.

Further, in the management system 100e, since the information used to estimate the liquid amount corresponding to the liquid container ID in a new product state can be easily acquired from the cloud server 50 and easily used to update the information when there are a plurality of liquid containers 10e, various conditions can be handled.

### Modified Embodiment

The liquid container 10e and the management device 40e of the sixth embodiment may be modified similarly to the liquid container 10b and the management device 40b of the third embodiment.

When the management device 40e determines that the first temperature sensor 32 and the second temperature sensor 36 are abnormal, the determination result may be displayed on one or both of the display unit 33 and the display unit 403. The determination result may be notified to the cloud server 50.

Similar to the calculation processing unit 351 of the first embodiment, the calculation processing unit 351d of the liquid container 10e may be configured to determine the abnormality (failure) of the first temperature sensor 32 and the second temperature sensor 36. In the case of such a configuration, the liquid container 10e may display the possibility that any one or both of the first temperature sensor 32 and the second temperature sensor 36 have a failure on any one or both of the display unit 33 and the display unit 403. The possibility may be notified to the management device 40e. Further, the possibility may be notified to the cloud server 50.

Further, similar to the calculation processing unit 351c of the fourth embodiment, the calculation processing unit 351d of the liquid container 10e may be configured to determine whether the inclination sensor 37 has a failure on the basis of the inclination angle information included in the notification information. In the case of such a configuration, the calculation processing unit 351d may display the possibility that the inclination sensor 37 has a failure even when the value of the inclination angle indicated by the inclination angle information is outside the second specified range on any one or both of the display unit 33 and the display unit 403. The possibility may be notified to the management device 40e. Further, the possibility may be notified to the cloud server 50. The information of the second specified range may be included in the notification information. The information may be recorded in the calculation processing unit 402. The information may be acquired from a memory. Further, the information may be acquired from the cloud server 50.

The management device 40e and the liquid container 10e may acquire the information (for example, the temperature information and the inclination angle information) used for the abnormality determination of any one or all of the first temperature sensor 32, the second temperature sensor 36, and the inclination sensor 37 from the cloud server 50 and perform the abnormality determination of the first temperature sensor 32, the second temperature sensor 36, and the inclination sensor 37 on the basis of the acquired information.

Although the embodiments of the present invention have been described above in detail with reference to the drawings, the detailed configuration is not limited to this embodiment and designs and the like within the scope not deviating from the gist of the present invention are included therein.

What is claimed is:

1. A liquid container comprising:
a first temperature sensor which is configured to measure a temperature around the inside of the liquid container while not contacting a liquid inside a container body;
a second temperature sensor which is configured to measure a temperature of an environment provided with the liquid container while not contacting the liquid inside the liquid container body; and
a calculation processing unit which is configured to estimate a liquid temperature inside the liquid container on the basis of the temperature around the inside of the liquid container measured by the first temperature sensor and the temperature of the environment measured by the second temperature sensor.

2. The liquid container according to claim 1,
wherein the calculation processing unit is configured to estimate the liquid temperature inside the liquid container on the basis of a correlation between the liquid temperature inside the liquid container and the temperature of a portion provided with the first temperature sensor measured in advance and a correlation between the temperature of the portion provided with the first temperature sensor and the temperature of a portion provided with the second temperature sensor measured in advance.

3. The liquid container according to claim 1,
wherein the calculation processing unit is configured to notify any one or both of a liquid temperature estimated value and a liquid temperature warning inside the liquid container when the liquid temperature estimated value inside the liquid container satisfies a condition for executing a warning notification on the liquid temperature.

4. The liquid container according to claim 1,
wherein the calculation processing unit is configured to estimate the liquid temperature inside the liquid container for a predetermined period, calculate a liquid temperature change rate by using the liquid temperature estimated value inside the liquid container for a predetermined period, and determine that the liquid container has a failure when the calculated liquid temperature change rate is higher than a comparison liquid temperature change rate.

5. A liquid container management system comprising:
a liquid container which is configured to store a liquid; and
a management device which is configured to manage the liquid container,
wherein the liquid container includes a first temperature sensor which is configured to measure a temperature around the inside of the liquid container while not contacting a liquid inside a container body, a second temperature sensor which is configured to measure a temperature of an environment provided with the liquid container while not contacting the liquid inside the liquid container body, and a communication unit which is configured to transmit the temperature around the inside of the liquid container measured by the first temperature sensor and the temperature of the environment measured by the second temperature sensor to the management device, and
wherein the management device includes a calculation processing unit which is configured to estimate a liquid temperature inside the liquid container on the basis of the temperature around the inside of the liquid container and the temperature of the environment transmitted from the liquid container.

6. The liquid container management system according to claim 5,
wherein the calculation processing unit is configured to estimate the liquid temperature inside the liquid container on the basis of a correlation between the liquid temperature inside the liquid container and the temperature of a portion provided with the first temperature sensor measured in advance and a correlation between the temperature of the portion provided with the first temperature sensor and the temperature of a portion provided with the second temperature sensor measured in advance.

7. The liquid container management system according to claim 5,
wherein the calculation processing unit is configured to notify any one or both of a liquid temperature estimated value and a liquid temperature warning inside the liquid container when the liquid temperature estimated value inside the liquid container satisfies a condition for executing a warning notification on the liquid temperature.

8. The liquid container management system according to claim 5,
wherein the management device is configured to acquire information necessary to determine whether the liquid container has a failure from other than the management device and the calculation processing unit is configured to determine that the liquid container has a failure when the acquired information satisfies a condition for determining that the liquid container has a failure.

9. The liquid container management system according to claim 8,
wherein the calculation processing unit is configured to estimate the liquid temperature inside the liquid container for a predetermined period, calculate a liquid temperature change rate by using the liquid temperature estimated value inside the liquid container for a predetermined period, and determine that the liquid container has a failure when the calculated liquid temperature change rate is higher than a comparison liquid temperature change rate.
